(19) United States
(12) Patent Application Publication
(10) Pub. No.: US 2018/0002451 A1
(43) Pub. Date: Jan. 4, 2018

(54) Starch Foams Using Specialized Lignin

(71) Applicant: Sweetwater Energy, Inc., Rochester, NY (US)

(72) Inventors: Changfeng GE, Pittsford, NY (US); Robert Aldi, Rochester, NY (US); Baxter Lansing, Ontario, NY (US); Scott Tudman, Honeoye Falls, NY (US)

(21) Appl. No.: 15/430,370

(22) Filed: Feb. 10, 2017

Related U.S. Application Data
(60) Provisional application No. 62/293,464, filed on Feb. 10, 2016.

(51) Int. Cl. C08B 30/20; C07G 1/00; C08B 30/12; C08J 9/12; C08J 9/228; C08B 30/06

(52) U.S. Cl. CPC C08B 30/20; C08J 9/228; C08B 30/06; C08B 30/12; C08J 9/125; C07G 1/00; C08J 2201/03; C08J 2203/10; C08J 2205/06; C08J 2205/10

(57) ABSTRACT

This application provides a method of using a highly clarified and clean lignin, derived from a specific biorefinery process to make a starch foam and products of the same. The lignin can be used as a low cost filler substitute for starch and other substrates that are currently employed in foam applications. The lignin has the right mechanical, physical, thermoplastic and barrier properties to enable easy handling and to impart improved properties such as UV resistance, water resistance and other physical parameters to starch foams.

### CROSS-REFERENCE

This application claims the benefit of U.S. Provisional Application No. 62/293,464, filed Feb. 10, 2016, which application is incorporated herein by reference in its entirety.

### BACKGROUND OF THE INVENTION

Although the use of starch in loose-fill and other products gives advantages in the form of biodegradability and environmental protection, these products have been criticized for their imperfections and/or compromised performance. Thus, efforts have been intensified to find fillers that can be incorporated in the polyol packaging with lower bulk density and improved barrier properties, especially using more hydrophobic molecules.

Starch-based foams have significantly higher foam and bulk density and open cell and moisture than other foams. These matrices are also more sensitive to changes in relative humidity and temperature, and the higher amount of absorbed moisture does compromise the foams' mechanical integrity, ultimately resulting the formation of a wet or “soaked” foam. Further, they have a low fire retardant properties and UV resistance.

Technologies for producing bulk starch foams and forms with barrier properties are being explored. Modified starch foams using oil, adhesives, biomass, and various lignin products have been tried and shown improvements. However, the cost of materials, especially to produce more pure composite materials, is prohibitive to making a low cost starch/composite foam.

Lignin is one of the most common renewable resources on earth. It consists of natural polymers and is characterized by high strength, rigidity, UV light and flame resistance. Lignin is a very abundant naturally occurring polymer with good properties for many materials applications, which can play a role in replacing or part replacing petroleum-based components in a broad range of composite materials. When it is extracted from plants, however, its amorphous cross-linked polymers can separate into a variety of inconsistent, fibrous substances partially bound to carbohydrate and other cell wall components depending on the type of hydrolysis used in separation processes. This is partly because lignin is a byproduct of harsh processes to extract cellulose and other components of biomass and it has been difficult and expensive to clean after such extractions. The lignin substances produced as a byproduct of the cellulose industry that use extreme pretreatments of lignocellulosic materials come at high costs of cleaning such materials and often have inferior and inconsistent properties as compared to synthetically-derived products. Most of this lignin is formed into pellets or bricks and burned.

A more uniform and low-cost hydrophobic lignin is needed for industrial scale production of usable polymers and films. The value-added applications of lignin would not only help to boost the economic viability of the bioethanol industry but also serve as a source of renewable materials.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A and 1B are micrographs (X190) of the lignin fraction from the second generation cellulosic plant production.

FIGS. 2A and 2B are graphs showing water absorption capacity and uptake ratio respectively.

FIG. 3 shows TGA curves of the starch/lignin foam.

FIG. 4 shows derivative thermo-gravimetric curves of the starch/lignin foam.

FIGS. 5A and 5B shows SEM microscopic images (X35) of exemplary cross sections profiles of the starch/lignin foam.

FIGS. 6A-6F are SEM micrographs (X80) for Matrix-l-1 (6A), Matrix-l-2 (6B), SB-80/20-1 (6C), SB-80/20-2 (6D), SB-60/40-1 (6E), and SB-60/40-2 (6F).

### SUMMARY OF THE INVENTION

Disclosed here are expanded matrixes, comprising a mixture of starch comprising amylose and amylopectin, and clean lignin, the lignin being present in a %weight ratio of between 50:50 to 99:1 of the starch, the expanded matrix having a uniform distribution of cells throughout.

In some embodiments, the starch comprises approximately 10% to 90% amylose. In some embodiments, the starch consists of approximately 10%, 15%, 20%, 25%, 30%, 35%, 40%, 45%, 50%, 55%, 60%, 65%, 70%, 75%, 80%, 85%, or 90% amylose.

In some embodiments, the expanded matrix is produced by a process comprising extruding the mixture of starch and lignin under heat and pressure. In some embodiments, the extruder is a single-screw extruder, a twin-screw extruder, or a triple-screw extruder.

In some embodiments, the expanded matrix is produced in a mold.

In some embodiments, the matrix is flexible.

In some embodiments, the matrix is rigid.

In some embodiments, the expanded matrix has a lower compressive strength compared to an expanded matrix of pure starch. In some embodiments, the expanded matrix has a compressive strength of 0.10 to 0.18 MPa.

In some embodiments, the mixture comprises 1-10% by weight lignin, and the expanded matrix has a unit density of less than about 39 kg/m3, a resiliency of at least 63%, and a compressive strength of at least 0.14 MPa.

In some embodiments, the starch is chemically unmodified.

In some embodiments, the lignin is chemically unmodified.

In some embodiments, the expanded matrix comprises at least 10% by weight lignin, wherein the expanded matrix is configured to remain intact after immersion in water for longer than 12 h.

In some embodiments, the expanded matrix has a unit density of about 39 kg/m3, a resiliency of about 63%, and a compressive strength of about 0.18 MPa.

In some embodiments, the expanded matrix further comprises at least one additive which does not chemically interact with the starch or lignin.

In some embodiments, the expanded matrix comprises a uniform foam produced within a heated extruder.

In some embodiments, the mixture comprises 1-40% by weight lignin and further comprises 1-20% by weight cellulose fibers, the expanded matrix having a unit density of less than about 61 kg/m3, a resiliency of at least 56%, and a compressive strength of at least 0.18 MPa.

In some embodiments, the mixture comprises 1-40% by weight lignin and further comprises 1-5% by weight cellulose fibers, the expanded matrix having a unit density of less than about 37 kg/m3, a resiliency of at least about 61%, and a compressive strength of at least 0.16 MPa.

In some embodiments, the mixture comprises between 5-50% by weight lignin, and further comprises 0-20% by weight cellulose fibers, the expanded matrix remaining intact after immersion in water for longer than 12 h.

Also disclosed herein are methods of forming a product, comprising: mixing between about 1-50% by weight clean lignin and starch in an aqueous medium; and extruding the lignin-starch mixture under heat and pressure to form an expanded foam.

In some embodiments, the extruder is a single-screw extruder, a twin-screw extruder, or a triple-screw extruder.

In some embodiments, the starch comprises amylose and amylopectin.

In some embodiments, the expanded foam has a cellular structure having a uniform distribution of cells along a cross section thereof

In some embodiments, the starch is chemically unmodified, the lignin is chemically unmodified, the product further comprises cellulose fibers.

In some embodiments, the product comprises 20-40% by weight lignin and 5-20% by weight cellulose fibers, and the expanded product had a reduced water absorption capacity of 40-60% after immersion in water for 15 min compared to a pure starch expanded foam.

Also disclosed herein are products formed by a process comprising: mixing chemically unmodified starch and clean lignin in an aqueous medium, and extruding the mixture under sufficient heat and pressure to yield an expanded matrix, the expanded matrix having a uniform distribution of cells throughout, approximately 13±4.70 cells in cross section , and having a sufficient amount of lignin to provide water resistance to retain structural integrity in aqueous liquid.

Also disclosed herein are starch foams comprising clean lignin, wherein the foam has the following characteristics: (a) Lignin, wherein the size of the lignin particles is over 50% 20 μm in diameter; (b) A decreased water absorption rate; and (c) Increased hydrophobicity.

Also disclosed herein are methods of producing a starch-lignin foam comprising: (a) Combining clean lignin and starch with water; (b) Adding a blowing agent; (c) Adding a plasticizer; and (d) Subjecting the mixture to heat and pressure.

In some embodiments, the starch comprises 75% amylopectin and 25% amylase.

In some embodiments, the blowing agent consists of: sodium bicarbonate, magnesium stearate, stearic acid, citric acid, and combinations thereof.

In some embodiments, the plasticizer consists of: water, glycerol, propylene glycol, glucose, sorbitol, urea, ethylene glycol, and a combination thereof.

Also disclosed herein are starch foams comprising clean lignin, wherein the lignin is prepared with an extruder or another device that reduces the size of at least 50% of the lignin particles to approximately 20 μm.

In some embodiments, the lignin is pretreated with acid hydrolysis.

In some embodiments, the lignin is in solid residues separated from a solution with a flocculant. In some embodiments, the flocculant consists of K, or PEO.

In some embodiments, the starch is thermoplastic starch.

In some embodiments, the starch is derived from starch-containing materials consisting of corn, rice, sorghum, wheat, other grains, cassava, tapioca, potato, sweet potato, other tubers or root crops, or a combination thereof.

In some embodiments, the foam can comprise amylose at 5-95 wt %, 50-80 wt %, about 10 wt %, about 15-20 wt %, about 20-25 wt %, about 25-30 wt %, about 30-35 wt %, about 35-40 wt %, about 40-45 wt %, about 45-50 wt %, about 50-55 wt %, about 55-60 wt %, about 60-65 wt %, about 65-70 wt %, about 70-75 wt %, about 75-80 wt %, about 80-85 wt %, about 85-90 wt %, or about 95 wt %.

In some embodiments, the foam can comprise amylopectin at 5-95 wt %, 50-80 wt %, about 10 wt %, about 15-20 wt %, about 20-25 wt %, about 25-30 wt %, about 30-35 wt %, about 35-40 wt %, about 40-45 wt %, about 45-50 wt %, about 50-55 wt %, about 55-60 wt %, about 60-65 wt %, about 65-70 wt %, about 70-75 wt %, about 75-80 wt %, about 80-85 wt %, about 85-90 wt %, or about 95 wt %.

In some embodiments, the starch comprises about 75% amylopectin and 25% amylase.

In some embodiments, a blowing agent is added to the foam. In some embodiments, the blowing agent consists of: sodium bicarbonate, magnesium stearate, stearic acid, citric acid, and combinations thereof.

In some embodiments, a plasticizer is added to the foam.

In some embodiments, the plasticizer consists of: water, glycerol, propylene glycol, glucose, sorbitol, urea, ethylene glycol, and a combination thereof.

In some embodiments, the foam comprises other additives. In some embodiments, the additives comprise emulsifiers, cellulose, plant fibres, bark, kaolin, pectin, or another substance.

Also disclosed herein are methods of producing a water-resistant starch-lignin foam, the method comprising: (a) combining starch, glycerol, water, and a lignin composition to form a mixture; and (b) subjecting the mixture to an elevated temperature and an elevated pressure to form the water-resistant starch-lignin foam.

In some embodiments, the mixture is subjected to the elevated temperature and elevated pressure in an extruder. In some embodiments, the extruder is a single-screw extruder. In some embodiments, the extruder is a double-screw extruder.

In some embodiments, the elevated temperature is about 20° C. to about 200° C. In some embodiments, the elevated temperature is about 75° C. to about 150° C.

In some embodiments, the elevated pressure is about 1 MPa to about 20 MPa. In some embodiments, the elevated pressure is about 2.5 MPa to about 10 MPa.

In some embodiments, the water-resistant starch-lignin foam has decreased water absorption capacity in comparison to a starch foam produced by the same method without the lignin composition. In some embodiments, a water absorption capacity of the water-resistant starch-lignin foam is decreased by at least 10%, 20%, 30%, 40%, 50%, or 60% relative to a starch foam produced by the same method without the lignin composition. In some embodiments, a water absorption capacity of the water-resistant starch-lignin foam is decreased by at least 10% relative to a starch foam produced by the same method without the lignin composition. In some embodiments, a water absorption capacity of the water-resistant starch-lignin foam is decreased by at least 20% relative to a starch foam produced by the same method without the lignin composition. In some embodiments, a water absorption capacity of the water-resistant starch-lignin foam is decreased by at least 30% relative to a starch foam produced by the same method without the lignin composition. In some embodiments, a water absorption capacity of the water-resistant starch-lignin foam is decreased by at least 40% relative to a starch foam produced by the same method without the lignin composition. In some embodiments, a water absorption capacity of the water-resistant starch-lignin foam is decreased by at least 50% relative to a starch foam produced by the same method without the lignin composition.

In some embodiments, the water-resistant starch-lignin foam has a decreased water absorption rate in comparison to a starch foam produced by the same method without the lignin composition. In some embodiments, a water absorption rate of the water-resistant starch-lignin foam is decreased by at least about: 10%, 20%, 30%, 40%, 50%, or 60% relative to a starch foam produced by the same method without the lignin composition. In some embodiments, a water absorption rate of the water-resistant starch-lignin foam is decreased by at least 10% relative to a starch foam produced by the same method without the lignin composition. In some embodiments, wherein a water absorption rate of the water-resistant starch-lignin foam is decreased by at least 20% relative to a starch foam produced by the same method without the lignin composition. In some embodiments, wherein a water absorption rate of the water-resistant starch-lignin foam is decreased by at least 30% relative to a starch foam produced by the same method without the lignin composition. In some embodiments, a water absorption rate of the water-resistant starch-lignin foam is decreased by at least 40% relative to a starch foam produced by the same method without the lignin composition. In some embodiments, a water absorption rate of the water-resistant starch-lignin foam is decreased by at least 50% relative to a starch foam produced by the same method without the lignin composition. In some embodiments, a water absorption rate of the water-resistant starch-lignin foam is decreased by at least 60% relative to a starch foam produced by the same method without the lignin composition.

In some embodiments, the water-resistant starch-lignin foam has a density of at least about: 0.5 g/cm3, 0.6 g/cm3, 0.7 g/cm3, 0.8 g/cm3, or 0.9 g/cm3. In some embodiments, the water-resistant starch-lignin foam has a density of at least about 0.5 g/cm3. In some embodiments, the water-resistant starch-lignin foam has a density of at least about 0.6 g/cm3. In some embodiments, the water-resistant starch-lignin foam has a density of at least about 0.7 g/cm3. In some embodiments, the water-resistant starch-lignin foam has a density of at least about 0.8 g/cm3. In some embodiments, the water-resistant starch-lignin foam has a density of at least about 0.9 g/cm3.

In some embodiments, the water-resistant starch-lignin foam has a compressive strength of at least about: 0.5 MPa, 1 MPa, 2.5 MPa, or 5MPa. In some embodiments, the water-resistant starch-lignin foam has a compressive strength of at least about 0.5 MPa. In some embodiments, the water-resistant starch-lignin foam has a compressive strength of at least about 1 MPa. In some embodiments, the water-resistant starch-lignin foam has a compressive strength of at least about 2.5 MPa. In some embodiments, the water-resistant starch-lignin foam has a compressive strength of at least about 5 MPa.

In some embodiments, the lignin composition is clean lignin.

In some embodiments, the lignin composition comprises about 30% to about 95% lignin by dry weight.

In some embodiments, the lignin composition comprises less than about: 25%, 20%, 15%, 10%, or 5% cellulose by dry weight. In some embodiments, the lignin composition comprises less than about 25% cellulose by dry weight. In some embodiments, the lignin composition comprises less than about 20% cellulose by dry weight. In some embodiments, the lignin composition comprises less than about 15% cellulose by dry weight. In some embodiments, the lignin composition comprises less than about 10% cellulose by dry weight. In some embodiments, the lignin composition comprises less than about 5% cellulose by dry weight.

In some embodiments, the lignin composition comprises less than about: 5%, 4%, 3%, or 2% ash by dry weight. In some embodiments, the lignin composition comprises less than about 5% ash by dry weight. In some embodiments, the lignin composition comprises less than about 4% ash by dry weight. In some embodiments, the lignin composition comprises less than about 3% ash by dry weight. In some embodiments, the lignin composition comprises less than about 2% ash by dry weight.

In some embodiments, the lignin composition comprises less than about: 1%, 0.5%, 0.25%, 0.2% sulfur by dry weight. In some embodiments, the lignin composition comprises less than about 1% sulfur by dry weight. In some embodiments, the lignin composition comprises less than about 0.5% sulfur by dry weight. In some embodiments, the lignin composition comprises less than about 0.25% sulfur by dry weight. In some embodiments, the lignin composition comprises less than about 0.2% sulfur by dry weight.

In some embodiments, the lignin composition comprises less than about: 5%, 4%, 3%, or 2% protein by dry weight. In some embodiments, the lignin composition comprises less than about 5% protein by dry weight. In some embodiments, the lignin composition comprises less than about 4% protein by dry weight. In some embodiments, the lignin composition comprises less than about 3% protein by dry weight. In some embodiments, the lignin composition comprises less than about 2% protein by dry weight.

In some embodiments, the lignin composition comprises lignin particles ranging in size from about 1 μm to 100 μm. In some embodiments, the lignin composition comprises lignin particles at least 50% of which are about 20 μm or less in size.

In some embodiments, the starch and the lignin composition are present in the mixture in ratio of about 50:50 to about 99:1 (starch:lignin composition) by weight. In some embodiments, the starch and the lignin composition are present in the mixture in ratio of about 50:50 to about 90:10 (starch:lignin composition) by weight. In some embodiments, the starch and the lignin composition are present in the mixture in ratio of about 60:40 to about 80:20 (starch:lignin composition) by weight. In some embodiments, the starch and the lignin composition are present in the mixture in ratio of about 60:40 (starch:lignin composition) by weight. In some embodiments, the starch and the lignin composition are present in the mixture in ratio of about 80:20 (starch:lignin composition) by weight.

In some embodiments, the starch is present in the mixture at about 20% to about 80% by weight. In some embodiments, the starch is present in the mixture at about 20% to about 75% by weight. In some embodiments, the starch is present in the mixture at about 25% to about 65% by weight.

In some embodiments, the lignin composition is present in the mixture at about 0.5% to about 40% by weight. In some embodiments, the lignin composition is present in the mixture at about 4% to about 40% by weight. In some embodiments, the lignin composition is present in the mixture at about 9% to about 35% by weight.

In some embodiments, the glycerol is present in the mixture at about 5% to 50% by weight. In some embodiments, the glycerol is present in the mixture at about 15% to about 35% by weight. In some embodiments, the glycerol is present in the mixture at about 20% to about 30% by weight. In some embodiments, the glycerol is present in the mixture at about 25%.

In some embodiments, the water is present in the mixture at about 1% to about 50% by weight. In some embodiments, the water is present in the mixture at about 1% to about 25% by weight. In some embodiments, the water is present in the mixture at about 5% to about 15% by weight. In some embodiments, the water is present in the mixture at about 10% by weight.

Some embodiments further comprise combining one or more blowing agents into the mixture. In some embodiments, the one or more blowing agents comprise sodium bicarbonate, magnesium stearate, stearic acid, citric acid, or combinations thereof. In some embodiments, the one or more blowing agents comprise an acid and a base. In some embodiments, the one or more blowing agents comprise sodium bicarbonate and citric acid. In some embodiments, the one or more blowing agents individually are present in the mixture at about 0.1% to about 5% by weight. In some embodiments, the one or more blowing agents individually are present in the mixture at about 0.5% to about 2.5% by weight.

In some embodiments, the lignin composition is the solid residue after pretreatment and hydrolysis of a lignocellulosic biomass to produce a hydrolyzate. In some embodiments, the solid residue is not subjected to further treatment with a chemical after pretreatment or hydrolysis. In some embodiments, a flocculating agent was used when separating the solid residue from the hydrolyzate. In some embodiments, pretreatment of the lignocellulosic biomass is with an acid. In some embodiments, the acid was at from 0.05% to about 5% w/v during pretreatment. In some embodiments, during pretreatment of the lignocellulosic biomass, the lignocellulosic biomass is subject to an elevated temperature and an elevated pressure for less than about 20 s. In some embodiments, the elevated pressure is from about 200 to about 400 psi. In some embodiments, the elevated temperature is about 150° C. to about 300° C. In some embodiments, the pretreatment of the lignocellulosic biomass is performed in an extruder. In some embodiments, the extruder is a twin screw extruder. In some embodiments, the hydrolysis of the lignocellulosic biomass comprises treatment with one or more cellulases.

Also disclosed herein are water-resistant starch-lignin foams produced by: (a) combining starch, glycerol, water, and a lignin composition to form a mixture; and (b) subjecting the mixture to an elevated temperature and an elevated pressure to form a water-resistant starch-lignin foam.

In some embodiments, the mixture is subjected to the elevated temperature and elevated pressure in an extruder. In some embodiments, the extruder is a single-screw extruder. In some embodiments, the extruder is a double-screw extruder.

In some embodiments, the elevated temperature is about 20° C. to about 200° C. In some embodiments, the elevated temperature is about 75° C. to about 150° C.

In some embodiments, the elevated pressure is about 1 MPa to about 20 MPa. In some embodiments, the elevated pressure is about 2.5 MPa to about 10 MPa.

In some embodiments, the water-resistant starch-lignin foam has decreased water absorption capacity in comparison to a starch foam produced by the same method without the lignin composition. In some embodiments, a water absorption capacity of the water-resistant starch-lignin foam is decreased by at least 10%, 20%, 30%, 40%, 50%, or 60% relative to a starch foam produced by the same method without the lignin composition. In some embodiments, a water absorption capacity of the water-resistant starch-lignin foam is decreased by at least 10% relative to a starch foam produced by the same method without the lignin composition. In some embodiments, a water absorption capacity of the water-resistant starch-lignin foam is decreased by at least 20% relative to a starch foam produced by the same method without the lignin composition. In some embodiments, a water absorption capacity of the water-resistant starch-lignin foam is decreased by at least 30% relative to a starch foam produced by the same method without the lignin composition. In some embodiments, a water absorption capacity of the water-resistant starch-lignin foam is decreased by at least 40% relative to a starch foam produced by the same method without the lignin composition. In some embodiments, a water absorption capacity of the water-resistant starch-lignin foam is decreased by at least 50% relative to a starch foam produced by the same method without the lignin composition.

In some embodiments, the water-resistant starch-lignin foam has a decreased water absorption rate in comparison to a starch foam produced by the same method without the lignin composition. In some embodiments, a water absorption rate of the water-resistant starch-lignin foam is decreased by at least about: 10%, 20%, 30%, 40%, 50%, or 60% relative to a starch foam produced by the same method without the lignin composition. In some embodiments, a water absorption rate of the water-resistant starch-lignin foam is decreased by at least 10% relative to a starch foam produced by the same method without the lignin composition. In some embodiments, wherein a water absorption rate of the water-resistant starch-lignin foam is decreased by at least 20% relative to a starch foam produced by the same method without the lignin composition. In some embodiments, wherein a water absorption rate of the water-resistant starch-lignin foam is decreased by at least 30% relative to a starch foam produced by the same method without the lignin composition. In some embodiments, a water absorption rate of the water-resistant starch-lignin foam is decreased by at least 40% relative to a starch foam produced by the same method without the lignin composition. In some embodiments, a water absorption rate of the water-resistant starch-lignin foam is decreased by at least 50% relative to a starch foam produced by the same method without the lignin composition. In some embodiments, a water absorption rate of the water-resistant starch-lignin foam is decreased by at least 60% relative to a starch foam produced by the same method without the lignin composition.

In some embodiments, the water-resistant starch-lignin foam has a density of at least about: 0.5 g/cm3, 0.6 g/cm3, 0.7 g/cm3, 0.8 g/cm3, or 0.9 g/cm3. In some embodiments, the water-resistant starch-lignin foam has a density of at least about 0.5 g/cm3. In some embodiments, the water-resistant starch-lignin foam has a density of at least about 0.6 g/cm3. In some embodiments, the water-resistant starch-lignin foam has a density of at least about 0.7 g/cm3. In some embodiments, the water-resistant starch-lignin foam has a density of at least about 0.8 g/cm3. In some embodiments, the water-resistant starch-lignin foam has a density of at least about 0.9 g/cm3.

In some embodiments, the water-resistant starch-lignin foam has a compressive strength of at least about: 0.5 MPa, 1 MPa, 2.5 MPa, or 5MPa. In some embodiments, the water-resistant starch-lignin foam has a compressive strength of at least about 0.5 MPa. In some embodiments, the water-resistant starch-lignin foam has a compressive strength of at least about 1 MPa. In some embodiments, the water-resistant starch-lignin foam has a compressive strength of at least about 2.5 MPa. In some embodiments, the water-resistant starch-lignin foam has a compressive strength of at least about 5 MPa.

In some embodiments, the lignin composition is clean lignin.

In some embodiments, the lignin composition comprises about 30% to about 95% lignin by dry weight.

In some embodiments, the lignin composition comprises less than about: 25%, 20%, 15%, 10%, or 5% cellulose by dry weight. In some embodiments, the lignin composition comprises less than about 25% cellulose by dry weight. In some embodiments, the lignin composition comprises less than about 20% cellulose by dry weight. In some embodiments, the lignin composition comprises less than about 15% cellulose by dry weight. In some embodiments, the lignin composition comprises less than about 10% cellulose by dry weight. In some embodiments, the lignin composition comprises less than about 5% cellulose by dry weight.

In some embodiments, the lignin composition comprises less than about: 5%, 4%, 3%, or 2% ash by dry weight. In some embodiments, the lignin composition comprises less than about 5% ash by dry weight. In some embodiments, the lignin composition comprises less than about 4% ash by dry weight. In some embodiments, the lignin composition comprises less than about 3% ash by dry weight. In some embodiments, the lignin composition comprises less than about 2% ash by dry weight.

In some embodiments, the lignin composition comprises less than about: 1%, 0.5%, 0.25%, 0.2% sulfur by dry weight. In some embodiments, the lignin composition comprises less than about 1% sulfur by dry weight. In some embodiments, the lignin composition comprises less than about 0.5% sulfur by dry weight. In some embodiments, the lignin composition comprises less than about 0.25% sulfur by dry weight. In some embodiments, the lignin composition comprises less than about 0.2% sulfur by dry weight.

In some embodiments, the lignin composition comprises less than about: 5%, 4%, 3%, or 2% protein by dry weight. In some embodiments, the lignin composition comprises less than about 5% protein by dry weight. In some embodiments, the lignin composition comprises less than about 4% protein by dry weight. In some embodiments, the lignin composition comprises less than about 3% protein by dry weight. In some embodiments, the lignin composition comprises less than about 2% protein by dry weight.

In some embodiments, the lignin composition comprises lignin particles ranging in size from about 1 μm to 100 μm. In some embodiments, the lignin composition comprises lignin particles at least 50% of which are about 20 μm or less in size.

In some embodiments, the starch and the lignin composition are present in the mixture in ratio of about 50:50 to about 99:1 (starch:lignin composition) by weight. In some embodiments, the starch and the lignin composition are present in the mixture in ratio of about 50:50 to about 90:10 (starch:lignin composition) by weight. In some embodiments, the starch and the lignin composition are present in the mixture in ratio of about 60:40 to about 80:20 (starch:lignin composition) by weight. In some embodiments, the starch and the lignin composition are present in the mixture in ratio of about 60:40 (starch:lignin composition) by weight. In some embodiments, the starch and the lignin composition are present in the mixture in ratio of about 80:20 (starch:lignin composition) by weight.

In some embodiments, the starch is present in the mixture at about 20% to about 80% by weight. In some embodiments, the starch is present in the mixture at about 20% to about 75% by weight. In some embodiments, the starch is present in the mixture at about 25% to about 65% by weight.

In some embodiments, the lignin composition is present in the mixture at about 0.5% to about 40% by weight. In some embodiments, the lignin composition is present in the mixture at about 4% to about 40% by weight. In some embodiments, the lignin composition is present in the mixture at about 9% to about 35% by weight.

In some embodiments, the glycerol is present in the mixture at about 5% to 50% by weight. In some embodiments, the glycerol is present in the mixture at about 15% to about 35% by weight. In some embodiments, the glycerol is present in the mixture at about 20% to about 30% by weight. In some embodiments, the glycerol is present in the mixture at about 25%.

In some embodiments, the water is present in the mixture at about 1% to about 50% by weight. In some embodiments, the water is present in the mixture at about 1% to about 25% by weight. In some embodiments, the water is present in the mixture at about 5% to about 15% by weight. In some embodiments, the water is present in the mixture at about 10% by weight.

Some embodiments further comprise combining one or more blowing agents into the mixture. In some embodiments, the one or more blowing agents comprise sodium bicarbonate, magnesium stearate, stearic acid, citric acid, or combinations thereof. In some embodiments, the one or more blowing agents comprise an acid and a base. In some embodiments, the one or more blowing agents comprise sodium bicarbonate and citric acid. In some embodiments, the one or more blowing agents individually are present in the mixture at about 0.1% to about 5% by weight. In some embodiments, the one or more blowing agents individually are present in the mixture at about 0.5% to about 2.5% by weight.

In some embodiments, the lignin composition is the solid residue after pretreatment and hydrolysis of a lignocellulosic biomass to produce a hydrolyzate. In some embodiments, the solid residue is not subjected to further treatment with a chemical after pretreatment or hydrolysis. In some embodiments, a flocculating agent was used when separating the solid residue from the hydrolyzate. In some embodiments, pretreatment of the lignocellulosic biomass is with an acid. In some embodiments, the acid was at from 0.05% to about 5% w/v during pretreatment. In some embodiments, during pretreatment of the lignocellulosic biomass, the lignocellulosic biomass is subject to an elevated temperature and an elevated pressure for less than about 20 s. In some embodiments, the elevated pressure is from about 200 to about 400 psi. In some embodiments, the elevated temperature is about 150° C. to about 300° C. In some embodiments, the pretreatment of the lignocellulosic biomass is performed in an extruder. In some embodiments, the extruder is a twin screw extruder. In some embodiments, the hydrolysis of the lignocellulosic biomass comprises treatment with one or more cellulases.

### DETAILED DESCRIPTION OF THE INVENTION

The production of lignin polymers and films has been inhibited by the cost of cleaning and modifying the type of lignin produced in most cellulose extraction processes. The amount of lignin and its attachment to other plant components varies in plant species, making it an inconsistent source of material. Further, the extraction of lignin from lignocellulo sic materials occurs under conditions where lignin is progressively broken down to lower molecular weight fragments, resulting in major changes to its physicochemical properties. Thus, in addition to the source of the lignin, the method of extraction will have a significant influence on composition and properties of lignin.

This disclosure provides lignin with improved properties such as workability and other physical and chemical characteristics that can be combined with starch to produce improved starch matrices, in particular, starch/lignin foams. The lignin disclosed herein has the ability to form polymer blends with improved properties with minimal or no modification following extraction from biomass materials.

Much of the woody feedstock used in cellulose extraction produces pulp and paper industrial by-products made through the Kraft process, and other processes that result in a lignin-rich residue but one that is highly-sulfonated and wherein the reactive sites on the lignin molecules are blocked. Further, all of these types of processes, whether the lignin feedstock is the whole or partial plant, or produced by an extraction process through Kraft, steam-explosion, high-temperature pyrolysis, or another method, result in long carbon fibers and a high ash content, and often, as in the case of pyrolysis, a condensed material with reduced pores. See, e.g., U.S. Publication 2015/0197424 A1. Lignin produced by solubilization in organic solvents has issues as well and is likely to have low hydrophobicity. Further, there is great expense in producing such lignin. Thus, most lignin residues today are produced in systems and by processes that result in a lignin product that requires much further washing and treatment to be useful in for anything but a fuel.

The cellulosic biorefinery industry integrates biomass conversion processes and equipment to produce sugars, fuels, power, heat, and value-added chemicals from biomass. Most biorefinery lignin extraction and delignification processes occur by either acid or base-catalyzed mechanisms or through organic solvents (organosolv lignin). Lignin can be isolated in fractions of varying molecular weight and can readily be functionalized to play a role in a broad range of composite materials. In addition, lignin can serve as a feedstock for the production of both solid and liquid fuel and a broad range of commodity chemicals. The importance of lignin in these applications is likely to increase, as society becomes less tolerant of product streams that dispose of lignin by landfill or burning and as the exploitation of lignocellulosic sources for biofuels increase the amount of lignin generated.

Widespread exploitation of these lignocellulosic sources could also dramatically change the nature of the lignin isolated: today most lignin is hydrophilic, sulfated material produced as a by-product of the pulp and paper industry, but the thermal, chemical, and biological methods employed in digesting lignocellulosic material are all likely to give rise to unfunctionalized lignin. For many applications, this material will be of superior quality, and hence the emergence of a viable lignocellulosic biofuels industry will afford a significant opportunity to apply lignin to a much greater extent in polymer composites, controlled-release formulations, and as a feedstock for fuels and commodity chemicals. Conversely, the development of these applications on a commercially viable scale will exert a ‘pull’ effect on lignocellulosic biofuel development, making the industry economically viable at an earlier stage of fossil fuel resource depletion. However, despite hundreds of years of experience in the pulping of biomass, technically feasible processes for separation of biomass into its main components still lie mostly below the threshold of economic viability. The present biorefinery treatment strategies, whether thermal, thermochemical or thermomechanical, still require considerable energy input and result in an inferior, inconsistent lignin product that requires further processing for most polymer composite applications.

Lignin is rich in aromatic rings and contains UV absorbing functional groups. In addition, the chromophores in the lignin structure make it a natural broad-spectrum sun-blocking entity. (Zimniewska M, et al. J Fiber Bioengin Informatics 2012:321-39; Glasser W G, et al. Lignin: Historical, Biological and Material Perspectives. 1999). Thus, it has excellent antioxidant properties and can increase thermal and oxidation stability of polymers in blends. Further, lignin and lignin blends have been found to have anti-microbial activity (Zimniewska, op cit.). These functionalities are more concentrated, the higher the purity of the lignin.

The processes described herein result in a cleaner, more uniform particle lignin with low sulfur and ash content and good hydrophobicity. The acid hydrolysis process used is much faster and more effective than traditional pretreatment processes and removes much of the enzymes, acid, sugars and other residues prior to lignin separation. The sugars are used to make useful end-products such as biofuels and bioplastics. Further the small particle size of the starting material (ensuring the lignin residues have a small particle size), the removal of most of the cellulose and hemicellulose, and impurities contributes to the small pore size and homogeneity in products. Because the pretreatment process is very efficient, the amount of residual cellulose is lowered and, following fermentation, flocculation not only separates the soluble sugars from the lignin residues, it adds to the hydrophobicity of the lignin residues.

Lignocellulosic biomass, including wood, requires high temperatures to depolymerize the sugars contained within and, in some cases, explosion and more violent reaction with steam (explosion) and/or acid to make it ready for enzyme hydrolysis. The C5 and Co sugars are naturally embedded in and cross-linked with lignin, extractives and phenolics. The high temperature and pressures result in the leaching of lignin but can also cause buildup of inhibitors and ash. A rapid process to pretreat lignocellulosic biomass after it has been cut or ground to a uniform particle size reduces this buildup results in a consistent even lignin product. In many instances, these lignin residues are highly suited for production of polymers and films, and are especially suited for particular applications that require a clean lignin with high hydrophobicity.

In this specification and in the claims that follow, reference will be made to a number of terms which shall be defined to have the following meanings.

Definitions

As used in the specification and the appended claims, the singular forms “a,” “an” and “the” include plural referents unless the context clearly dictates otherwise. Thus, for example, reference to “a purified monomer” includes mixtures of two or more purified monomers. The term “comprising” as used herein is synonymous with “including,” “containing,” or “characterized by,” and is inclusive or open-ended and does not exclude additional, unrecited elements or method steps.

“About” means a referenced numeric indication plus or minus 10% of that referenced numeric indication. For example, the term about 4 would include a range of 3.6 to 4.4. All numbers expressing quantities of ingredients, reaction conditions, and so forth used in the specification are to be understood as being modified in all instances by the term “about.” Accordingly, unless indicated to the contrary, the numerical parameters set forth herein are approximations that can vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Wherever the phrase “for example,” “such as,” “including” and the like are used herein, the phrase “and without limitation” is understood to follow unless explicitly stated otherwise. Therefore, “for example ethanol production” means “for example and without limitation ethanol production.”

“Optional” or “optionally” means that the subsequently described event or circumstance may or may not occur, and that the description includes instances where said event or circumstance occurs and instances where it does not. For example, the phrase “the medium can optionally contain glucose” means that the medium may or may not contain glucose as an ingredient and that the description includes both media containing glucose and media not containing glucose.

Unless characterized otherwise, technical and scientific terms used herein have the same meaning as commonly understood by one of ordinary skill in the art.

“Fermentive end-product” and “fermentation end-product” are used interchangeably herein to include activated carbon, biofuels, chemicals, compounds suitable as liquid fuels, gaseous fuels, triacylglycerols, reagents, chemical feedstocks, chemical additives, processing aids, food additives, bioplastics and precursors to bioplastics, and other products.

The term “lignin” as used herein has its ordinary meaning as known to those skilled in the art and can comprise a cross-linked organic, racemic phenol polymer with molecular masses in excess of 10,000 microns that is relatively hydrophobic and aromatic in nature. Its degree of polymerization in nature is difficult to measure, since it is fragmented during extraction and the molecule consists of various types of substructures that appear to repeat in a haphazard manner. There are three monolignol monomers, methoxylated to various degrees: p-coumaryl alcohol, coniferyl alcohol, and sinapyl alcohol. These lignols are incorporated into lignin in the form of the phenylpropanoidsp-hydroxyphenyl (H), guaiacyl (G), and syringyl (S), respectively. All lignins contain small amounts of incomplete or modified monolignols, and other monomers are prominent in non-woody plants. Lignins are one of the main classes of structural materials in the support tissues of vascular and nonvascular plants and some algae. Lignins are particularly important in the formation of cell walls, especially in wood and bark. It is one of the most abundant polymers on earth.

The term “pyrolysis” as used herein has its ordinary meaning as known to those skilled in the art and generally refers to thermal decomposition of a lignocellulo sic biomass. In pyrolysis, less oxygen is present than is required for complete combustion, such as less than 10%. In some embodiments, pyrolysis can be performed in the absence of oxygen.

The term “ash” as used herein has its ordinary meaning as known to those skilled in the art and generally refers to any solid residue that remains following a combustion process, and is not limited in its composition. Ash is generally rich in metal oxides, such as SiO₂, CaO, Al₂O₃, and K₂O. “Carbon-containing ash” or “carbonized ash” means ash that has at least some carbon content. Fly ash, also known as flue ash, is one of the residues generated in combustion, and comprises the fine particles that rise with the flue gases. Ash which does not rise is termed bottom ash. Fly ash is generally captured by electrostatic precipitators or other particle filtration equipment before the flue gases are emitted. The bottom ash is typically removed from the bottom of the furnace.

The term “biomass” as used herein is has its ordinary meaning as known to those skilled in the art and can include one or more carbonaceous biological materials that can be converted into a biofuel, chemical or other product. Biomass as used herein is synonymous with the term “feedstock” and includes corn syrup, molasses, silage, sorghum, agricultural residues (corn stalks, grass, straw, grain hulls, bagasse, etc.), animal waste (manure from cattle, poultry, and hogs), Distillers Dried Solubles (DDS), Distillers Dried Grains (DDG), Condensed Distillers Solubles (CDS), Distillers Wet Grains (DWG), Distillers Dried Grains with Solubles (DDGS), woody materials (wood or bark, sawdust, wood chips, timber slash, and mill scrap), municipal waste (waste paper, recycled toilet papers, yard clippings, etc.), and energy crops (poplars, willows, switchgrass, alfalfa, prairie bluestem, algae, including macroalgae, etc.). One exemplary source of biomass is plant matter. Plant matter can be, for example, woody plant matter, non-woody plant matter, cellulosic material, lignocellulosic material, hemicellulosic material, carbohydrates, pectin, starch, inulin, fructans, glucans, corn, sugar cane, grasses, switchgrass, sorghum, high biomass sorghum, bamboo, algae and material derived from these. Plants can be in their natural state or genetically modified, e.g., to increase the cellulosic or hemicellulosic portion of the cell wall, or to produce additional exogenous or endogenous enzymes to increase the separation of cell wall components. Plant matter can be further described by reference to the chemical species present, such as proteins, polysaccharides and oils. Polysaccharides include polymers of various monosaccharides and derivatives of monosaccharides including glucose, fructose, lactose, galacturonic acid, rhamnose, etc. Plant matter also includes agricultural waste byproducts or side streams such as pomace, corn steep liquor, corn steep solids, distillers grains, peels, pits, fermentation waste, straw, lumber, sewage, garbage and food leftovers. Peels can be citrus which include, but are not limited to, tangerine peel, grapefruit peel, orange peel, tangerine peel, lime peel and lemon peel. These materials can come from farms, forestry, industrial sources, households, etc. Another non-limiting example of biomass is animal matter, including, for example milk, meat, fat, animal processing waste, and animal waste. “Feedstock” is frequently used to refer to biomass being used for a process, such as those described herein.

“Concentration” when referring to material in the broth or in solution generally refers to the amount of a material present from all sources, whether made by the organism or added to the broth or solution. Concentration can refer to soluble species or insoluble species, and is referenced to either the liquid portion of the broth or the total volume of the broth, as for “titer.” When referring to a solution, such as “concentration of the sugar in solution”, the term indicates increasing one or more components of the solution through evaporation, filtering, extraction, etc., by removal or reduction of a liquid portion.

“Pretreatment” or “pretreated” is used herein to refer to any mechanical, chemical, thermal, biochemical process or combination of these processes whether in a combined step or performed sequentially, that achieves disruption or expansion of the biomass so as to render the biomass more susceptible to attack by enzymes and/or microbes, and can include the enzymatic hydrolysis of released carbohydrate polymers or oligomers to monomers. In one embodiment, pretreatment includes removal or disruption of lignin so as to make the cellulose and hemicellulose polymers in the plant biomass more available to cellulolytic enzymes and/or microbes, for example, by treatment with acid or base. In one embodiment, pretreatment includes disruption or expansion of cellulosic and/or hemicellulosic material. In another embodiment, it can refer to starch release and/or enzymatic hydrolysis to glucose. Steam explosion, and ammonia fiber expansion (or explosion) (AFEX) are well known thermal/chemical techniques. Hydrolysis, including methods that utilize acids, bases, and/or enzymes can be used. Other thermal, chemical, biochemical, enzymatic techniques can also be used.

“Sugar compounds” or “sugar streams” is used herein to indicate mostly monosaccharide sugars, dissolved, crystallized, evaporated, or partially dissolved, including but not limited to hexoses and pentoses; sugar alcohols; sugar acids; sugar amines; compounds containing two or more of these linked together directly or indirectly through covalent or ionic bonds; and mixtures thereof. Included within this description are disaccharides; trisaccharides; oligosaccharides; polysaccharides; and sugar chains, branched and/or linear, of any length. A sugar stream can consist of primarily or substantially C6 sugars, C5 sugars, or mixtures of both C6 and C5 sugars in varying ratios of said sugars. C6 sugars have a six-carbon molecular backbone and C5 sugars have a five-carbon molecular backbone.

A “liquid” composition may contain solids and a “solids” composition may contain liquids. A liquid composition refers to a composition in which the material is primarily liquid, and a solids composition is one in which the material is primarily solid.

The term “fatty acid” refers to a carboxylic acid with an aliphatic tail which may be saturated or unsaturated. The term includes short chain fatty acids (2-5 carbon aliphatic tail), medium chain fatty acids (6-12 carbon aliphatic tail), long chain fatty acids (13-21 carbon aliphatic tail), very long chain fatty acids (22 or greater carbon aliphatic tail), fatty acid of phosphatidylethanolamine, a fatty acid of soybean lecithin, or an unsaturated fatty acid of egg lecithin.

The term “polymer” may be a natural, a semisynthetic polymer, or a synthetic polymer. Examples of such polymers include albumins, aliginic acids, carboxymethylcelluloses, sodium salt cross-linked, celluloses, cellulose acetates, cellulose acetate butyrates, cellulose acetate phthalates, cellulose acetate trimelliates, chitins, chitosans, collagens, dextrins, ethylcelluloses, gelatins, guargums, hydroxypropylmethyl celluloses (HPC), karana gums, methyl celluloses, poloxamers, polysaccharides, lignin, silk protein, sodium starch glycolates, starch thermally modifieds, tragacanth gums, or xanthangum polysaccharides. The polymer can be a linear polymer, a ring polymer, a branched polymer, e.g., a dendrimer. The polymer may or may not be cross-linked.

The polymer can be a homopolymer, a copolymer, a block copolymer with monomers from one or more the polymers above. If the polymer comprises asymmetric monomers, it may be regio-regular, isotactic or syndiotactic (alternating); or region-random, atactic. If the polymer comprises chiral monomers, the polymer may be stereo-regular or a racemic mixture, e.g., poly(D-, L-lactic acid). It may be a random copolymer, an alternating copolymer, a periodic copolymer, e.g., repeating units with a formula such as [AₙBₘ]. The polymer can be a block copolymer comprising a hydrophilic block polymer and a hydrophobic block polymer.

The polymer can comprise derivatives of individual monomers chemically modified with substituents, including without limitation, alkylation, e.g., (poly C₁-C₁₆ alkyl methacrylate), amidation, esterification, ether, or salt formation. The polymer can also be modified by specific covalent attachments the backbone (main chain modification) or ends of the polymer (end group modifications). Examples of such modifications include attaching PEG (PEGylation) or albumin.

In certain embodiments, the polymer can be a poly(dioxanone). The poly(dioxanone) can be poly(p-dioxanone), see U.S. Pat. Nos. 4,052,988; 4,643,191; 5,080,665; and 5,019,094, the contents of which are hereby incorporated by reference in their entirety. The polymer can be a copolymer of poly(alkylene oxide) and poly(p-dioxanone), such as a block copolymer of poly(ethylene glycol) (PEG) and poly(p-dioxanone) which may or may not include PLA, see U.S. Pat. No. 6,599,519, the content of which is hereby incorporated by reference in its entirety.

In some embodiments, the polymer can be a polyethylene oxide (PEO). Examples of PEO block copolymers include U.S. Pat. Nos. 5,612,052 and 5,702,717, the contents of which are hereby incorporated by reference in their entirety. In some embodiments, a polymeric matrix can be a polylactide (PLA), including poly(L-lactic acid), poly(D-lactic acid), poly(D-,L-lactic acid); a polyglycolide (PGA); poly(lactic-co-glycolic acid) (PLGA); poly (lactic-co-dioxanone) (PLDO) which may or may not include polyethylene glycol (PEG). See U.S. Pat. Nos. 4,862,168; 4,452,973; 4,716,203; 4,942,035; 5,384,333; 5,449,513; 5,476,909; 5,510,103; 5,543,158; 5,548,035; 5,683,723; 5,702,717; 6,616,941; 6,916,788, PLA-PEG, PLDO-PEG, PLGA-PEG), 7,217,770 (PEG-PLA); 7,311,901 (amphophilic copolymers); 7,550,157 (mPEG-PCL, mPEG-PLA, mPEG-PLDO, mPEG-PLGA, and micelles); U.S. Pat. Pub. No. 2010/0008998 (PEG2000/4000/10,000-mPEG-PLA); PCT Pub. No. 2009/084801 (mPEG-PLA and mPEG-PLGA micelles), or pDADMAC, the contents of which are hereby incorporated by reference in their entirety.

### Description

The following description and examples illustrate some exemplary embodiments of the disclosure in detail. Those of skill in the art will recognize that there are numerous variations and modifications of this disclosure that are encompassed by its scope. Accordingly, the description of a certain exemplary embodiment should not be deemed to limit the scope of the present disclosure.

The invention relates to technologies in converting heat-treated lignin, such as the waste-generated directly from biofuel production, into lignin-based starch foam and foam sheet for packaging and agricultural application through thermal and mechanical processes.

Assuming most of the cellulose and hemicellulose in the lignocellulose are full converted to sugars during hydrolysis of the biomass, at least 30% of the intake biomass is left as solid residuals, mainly in the form of lignin and some unhydrolysed carbohydrate. The discharge of the biomass in a lignocellulose biorefinery process can be split into one or two waste streams, depending on the process followed. In one instance, the C5 sugar stream in polymer or monomer form, separated from the lignin-C6 bound solids, can be removed prior to the hydrolysis of the C6 carbohydrate from lignin. Then the C6 polymers are hydrolyzed and released from the lignin. In another instance, both C5 and C6 carbohydrate fractions are hydrolyzed from the lignin and fermented. The lignin residuals are considered the “solids” fraction and then separated from the solubilized carbohydrate.

In one embodiment, the lignin residuals are separated by flocculation and then filtration. The flocculant used can vary, but is primarily non-ionic and biodegradable. One such flocculant is non-ionic PEO. This results, on a dry basis, of anywhere between 0.1 and 1.0 mg PEO per kg of lignin cake. Typically, it would be in the 0.3-0.5 mg PEO/kg lignin cake range. The PEO is non-ionic, it's a flocculating agent that agglomerates the lignin. It is very selective to lignin; however, if there is too much unconverted cellulose, it may not be as effective as a flocculant. PEO and other flocculants are used as an additive in some typed of polyols/plastics, so it works as an additional hydrophobic enhancement to the low carbohydrate lignin product.

In some embodiments, the flocculant can be another polymer. Suitable polymers can be a polyamide, a polyacrylamide, a polyester, a polycarbonate, a hydroxypropylmethylcellulose, polyvinylchloride, polymethacrylate, polystyrene and copolymers thereof, polyvinyl alcohol, polyacrylic acid, polyethylene oxide, and combinations thereof, among others. The polymers used in the compositions, systems, and methods of this invention can be cationic, anionic, non-ionic, amphoteric, or combinations thereof. Furthermore, the polymers used in these compositions, systems, and methods can have various molecular weights and various charge densities. In some embodiments, a polymer comprises lignins, proteins, lipids, surfactants, carbohydrates, small molecules, and/or polynucleotides or any of the polymers described supra.

These lignin residuals, instead of resulting in a variable aromatic structure and hydrophilic molecular weight mass, tend to be more uniform, hydrophobic and present a cleaner lignin product than that from pulp and paper industries and other biorefineries. In addition, the rapid pretreatment time of this particular process, results in fewer inhibitory contaminants. Thus, the biofuel production described herein provides large-scale, heat-treated clean lignin that can be processed directly into packaging and agricultural products via thermal and mechanical processes.

Lignocellulosic materials useful for this process can include, for example, wood, sawdust, wood chips, vegetable or animal matter, plant residues, and plant and animal waste residues from plants and animal matter, respectively, that have been processed to extract chemical compounds such as proteins, carbohydrates, and minerals. In another embodiment, municipal solid waste can be used in this process. In a further embodiment, the lignocellulosic biomasss can be selected from: timber harvesting residues, agricultural residues, softwood chips, hardwood chips, tree branches, stumps, leaves, off-spec paper pulp, cellulose, corn, corn fiber, corncobs, sorghum, corn stover, wheat straw, rice straw, sugarcane bagasse, algae, switchgrass, Miscanthus sp., animal manure, municipal garbage municipal sewage, commercial waste grape pumice, vinasse, nuts, nut shells, coconut shells, coffee grounds, grass pellets, hay pellets, wood pellets, cardboard, paper, carbohydrates, and cloth. A person of ordinary skill in the art will readily appreciate that the feedstock options are virtually unlimited.

The uniform thermal treatment in steam or steam explosion processes and further hydrolysis will permanently change the molecular structure of the lignin residuals, making them more hydrophobic. Incorporation of the same into starch foams will change the hydrophilic nature of the starch foam, giving the foam properties different from other starch foams, including other starch-lignin foams.

Starch is a polysaccharide made up of glucose units linked by glycoside linkages, and its length is generally between 500-2000 repeat units. It is made up of amylose and amylopectin. Amylose is more linear and gives the foam flexibility and keeps the density low, while amylopectin is highly branched and makes the product more foamable. Starch is extracted from plants and other photosynthetic organisms or products comprising such materials.

Starch foams are usually produced by extrusion where the starch is melted and mixed with a blowing agent. The blowing agent for starch is often water or methanol, which is turned into steam when the system is heated and forms air bubbles within the starch matrix. The extrusion process is a continuous, low-cost method that is easy to use. It is difficult to make the foam smooth and have a high number of closed cells. The use of thermoplastic polymer additives can help even out the surfaces, but can also decrease the degradability of the foam by incorporating slowly degrading or non-degradable polymers. The foams can be flexible or rigid by changing the chemistry, density, structure and raw materials used.

The starch-lignin foams are prepared using any conventional thermoplastics single or dual screw extruder with a die for foamed products. The die can be designed to maintain backpressure. The raw materials are preweighed, mixed and fed into the material inlet of the extruder. Raw materials include starch, clean lignin, plasticizer, water, blowing agents and/or other materials.

The particular lignin of this invention is an acid-hydrolyzed, treated under high steam pressure, and separated, after enzymatic hydrolysis, with a flocculant and filtration. The advantage of this lignin is that it is more hydrophobic than other biorefinery lignins and can be used without further chemical modification. Its composition is approximately 1-25% carbohydrate (primarily cellulose), it has a low sulfur and ash content, and is hydrophobic (due to unique separation techniques). It has a short uniform particle size and the lignin fibers are generally around 20 μm in size. This is due to the particular processing of the biomass which, unlike most pretreatment processes, goes through a further reduction in size during acid and thermal treatment. Hereinafter, this lignin is called “clean lignin”.

The starch can be modified chemically or physically prior to use, or can be used in an unmodified state to reduce costs. Examples of starch or starch-containing materials include, but are not limited to, corn, rice, sorghum, other grains, cassava, tapioca, potato, sweet potato, other tubers or root crops, etc.) The starch can comprise 5-95 wt % amylose, preferably 50-80 wt % amylose. Other starches can be used or a combination of starches. Starch can comprise about lOwt %, about 15-20 wt %, about 20-25 wt %, about 25-30 wt %, about 30-35 wt %, about 35-40 wt %, about 40-45 wt %, about 45-50 wt %, about 50-55 wt %, about 55-60 wt %, about 60-65 wt %, about 65-70 wt %, about 70-75 wt %, about 75-80 wt %, about 80-85 wt %, about 85-90 wt %, or about 95 wt %.

Starch is readily dispersed in cold water. If heated to boiling in water, it changes and the starch/water mixture becomes a thickened, colloidal solution that gels on cooling. This process is known as destructuration since it involves destruction of the granule crystallites. However, starch can be plasticized (destructurized) by relatively low levels (15-30 wt %) of molecules that are capable of hydrogen bonding with the starch hydroxyl groups, such as water, glycerol and sorbitol This “thermoplastic starch” (TPS) will flow at elevated temperature and pressure and can be extruded to give both foams and solid molded articles.

TPS produced from starch plastifled only with water becomes very brittle at room temperature. To increase material flexibility and improve processing, other plasticizers are also used. Examples of plasticizers include, for example, water, glycerol, propylene glycol, glucose, sorbitol, urea, ethylene glycol, and the like. To improve the mechanical properties of the foam, other additives, such as emulsifiers, cellulose, plant fibres, bark, kaolin, pectin, and other substances, can be included. Those of skill in the art will understand that the addition of plasticizers and/or other aid materials can have a significant influence on the mechanical properties.

Polymer foams are made up of a solid and gas phase mixed together to form a foam. This generally happens by combining the two phases too fast for the system to respond in a smooth fashion. The resulting foam has a polymer matrix with either air bubbles or air tunnels incorporated in it, which is known as either closed-cell or open-cell structure. Closed-cell foams are generally more rigid, while open-cell foams are usually flexible.

The gas used in the foam is termed a blowing agent, and can be either derived from chemicals or physical. Chemical blowing agents are chemicals that take part in a reaction or decompose, giving off reactants in the process. Physical blowing agents are gases that do not react chemically in the foaming process and are therefore inert to the polymer forming the matrix.

Examples of blowing agents include, for example, sodium bicarbonate, magnesium stearate, stearic acid, and the like. The blowing agent activates and creates gasses that are responsible for foaming the starch-lignin matrix.

Examples of foaming agents include, for example, water, air, carbon dioxide, nitrogen, oxygen, air or alcohol.

The properties of simple thermoplastic starches tend to be disappointing. For example, TPS plasticized with water has poor dimensional stability and becomes brittle as water is lost, and the properties of water- and glycerol-plasticized TPS are poor at high humidity. TPS properties can be improved significantly by blending with other polymers, fillers, and fibers. Both natural and synthetic polymers have been used, including cellulose, zein (a protein from corn), natural rubber, polyvinyl alcohol, acrylate copolymers, polyethylene and ethylene copolymers, polyesters, and polyurethanes. Blends of TPS with other biodegradable polymers, such as polyvinyl alcohol or aliphatic polyesters like polylactic acid, polycaprolactone and poly(3-hydroxybutyrate) are fully biodegradable. For TPS blends with non-biodegradable polymers, it is likely that only the TPS component will biodegrade in a reasonable timeframe. Reinforced, 100% renewable TPS blends can be obtained by including natural fibers, such as wood pulp, hemp and other plant fibers. Almost all of these renewable components require extraction and costly cleanup to purify them to a uniform material that can produce a starch foam having consistent properties.

Lignin Preparation

Extrusion can mean the process of forcing a material through a specifically designed opening. For food processing and other types of processing materials, the principle of screw extruders is similar. They can employ low shear, deep-flight screws and operate a low screw speeds, for cooking, mixing, and forming materials, and for other appropriate purposes.

Modern extruders can consist of a basic drive assembly that is then outfitted with combinations of modular preconditioners, screw worms, barrel sections, dies and cutters to obtain the desired shearing, heating/cooling, and product shaping effects desired. They can comprise single, twin, and triple screws, depending on the application for which they are constructed. The operating costs for these systems are low compared to their output, because of reduced capital costs as well as increased energy efficiency.

Basically, whether in batch or continuous operation, the lignocellulosic biomass can be distributed in the reaction zone of the extruder as uniformly as possible and the pretreatment reaction take place with temperature, pressure and chemical treatment applied consistently throughout the material, and so that the total duration of the treatment of the material is lowered as much as possible, and the reactions are complete simultaneously throughout the material in order to increase the yield as much as possible without destroying the properties of the carbohydrates and lignin.

Steam explosion and/or acid hydrolysis of lignocellulosic biomass to produce sugars can be costly and requires special equipment. The process, especially under high temperatures and pressure, can release structural carbohydrates in cellulosic biomass and can expose crystalline cellulose to enzymatic degradation. The byproducts of acid hydrolysis and subsequent enzymatic hydrolysis and fermentation can be a solids mixture of unfermented carbohydrate, lignin, protein and minerals, often called “lignin residues”. On a dry weight basis, using an extruder with controls as described herein and enzymatic hydrolysis, the carbohydrate portion can vary from 1-30% but is normally less than 15%. The protein component can range from 1-5% and minerals (ash) can comprise from 0.1-4%. There can also be some remaining enzymes in the mixture. However, the largest component is typically lignin, which can range from 30-95%, depending on the type of biomass and what has already been solubilized.

The lignin produced by the processes described above is very clean, hydrophobic, and of a very small, uniform particle size, making it an excellent starting material for polymer foams and films. Particle size distribution of the residue from extruder pretreatment is within a small range. The particle size of lignin following further enzymatic hydrolysis to remove carbohydrate is even smaller and results in some of the lignin easily solubilized in solutions. These particles range from about 1 to 100 μm in size. In general, over 50% of the particles are 20 μm or smaller. Other lignins, such as those produced from Kraft processes, lignosulfonates, and acid and alkali barrel-type produced lignins are less uniform and not as clean due the harshness of the processes by which they are produced and/or the disproportionate size of the lignin particles that are in the residues. This means extra expense to clean and modify the residues or the products will have less strength and may be unsuitable for their purpose.

Lignocellulosic Material Handling

Mechanical processes can include, but are not limited to, washing, soaking, milling, grinding, size reduction, screening, shearing, size classification and density classification processes. Chemical processes can include, but are not limited to, bleaching, oxidation, reduction, acid treatment, base treatment, sulfite treatment, acid sulfite treatment, basic sulfite treatment, ammonia treatment, and hydrolysis. Thermal processes can include, but are not limited to, sterilization, ammonia fiber expansion or explosion (“AFEX”), steam explosion, holding at elevated temperatures, pressurized or unpressurized, in the presence or absence of water, and freezing. Biochemical processes can include, but are not limited to, treatment with enzymes, including enzymes produced by genetically-modified plants, and treatment with microorganisms. Various enzymes that can be utilized include cellulase, amylase, β-glucosidase, xylanase, gluconase, and other polysaccharases; lysozyme; laccase, and other lignin-modifying enzymes; lipoxygenase, peroxidase, and other oxidative enzymes; proteases; and lipases. One or more of the mechanical, chemical, thermal, thermochemical, and biochemical processes can be combined or used separately. The feedstock can be a side stream or waste stream from a facility that utilizes one or more of these processes on a biomass material, such as cellulosic, hemicellulosic or lignocellulosic material. Examples can include paper plants, cellulosics plants, distillation plants, cotton processing plants, and microcrystalline cellulose plants. The feedstock can also include cellulose-containing or cellulosic containing waste materials. The feedstock can also be biomass materials, such as wood, grasses, corn, starch, or sugar, produced or harvested as an intended feedstock for production of ethanol or other products such as by biocatalysts.

An exemplary extruder system that produces lignin residues can hydrolyze plant matter via steam, pressure, and high temperature, and can additionally use acid to convert carbohydrate polymers to monomers and oligomers. Further hydrolysis and bioproduct formation (products such as ethanol, other biofuels, and bioplastics or biochemicals) can be accomplished through enzymes, microorganisms, or both. The residual matter left from this process is very high in lignin, as well as containing some carbohydrate and protein. These lignin residues can be separated by further processing if necessary. An example of such a system and the processes therein can be found in US2016/0273009A1 the entirety of which is incorporated herein by reference.

The lignin residues can also be concentrated by any means, such as drying, evaporation, flocculation, filtration, centrifugation or a combination of these methods. They can be dried and can be shaped into pellets, bricks, or any desirable shape. In one embodiment, the lignin residues can be crumbled or ground into a powder.

The lignin produced through extruder pretreatment is cleaner and more uniform in chemistry and particle size than lignin residues produced with other pretreatment systems. No expensive solvents are needed to dissolve the lignin prior to pretreatment. The small particle size makes it easier to thoroughly hydrolyze with enzymes and thus higher yields of sugars are obtained as well as cleaner lignin residues. Various separation methods, including filtration, rotary press, centrifugation, flocculation, and the like, can be used to separate the sugars from the lignin. Once separated, the lignin can be placed in containers, formed into powders, pellets, bricks or any type of form for further use or transport.

This clean lignin is low cost to produce, has a low ash and sulfur content, and the particle size is small and uniform, unlike other biorefinery lignin and lignin produced from Kraft or sulfur processes. It is of high purity, having a low carbohydrate content (less than 12%) and is hydrophobic and more reactive than in its natural non-modified form. It is also homogeneous and porous.

Since the solid product generally comprises lignin and analogous materials it can be particularly difficult to separate from the liquor. Unexpectedly, it was found that the production of fermentation product and more hydrophobic lignin residue can be significantly improved by applying one or more flocculating agents to the separation of the hydrolysate from the solid product. We have found that the solid product can be more efficiently dewatered by the process and that a higher cake solids can be achieved. Since the solid product can be more efficiently dewatered there is a reduced requirement for separation equipment capacity and equipment that is less capital intensive and less expensive to operate, such as a filter press, can be used. Since higher cake solids can be achieved, less of the acid sugar solution remains in the residual by-product solid. Hence the quantity of water required to wash the by-product solid free of acid and sugar is much reduced, improving both the productivity and efficiency of the process as well as the quality of the lignin product.

Suitably the flocculating agent is selected from the group consisting of water soluble or water swellable natural, semi-natural and synthetic polymers. Preferably the polymer is synthetic and may be formed by polymerization of at least one cationic, non-ionic or and/or anionic monomer(s) alone or with other water soluble monomers. By water soluble, it is meant that the monomer has a solubility of at least 5 g/100 ml at 25° C.

Preferably polymeric flocculating agents are formed from ethylenically unsaturated water soluble monomers that readily polymerize to produce high molecular weight polymers. Particularly preferred polymers include monomers that are selected from the group consisting of polyacrylate salts, polyacrylamide, copolymers of acrylamide with (meth) acrylic acid or salts thereof, copolymers of acrylamide with dialkylaminoalkyl (meth) acrylate or acid addition or quatenary ammonium salts, polymers of diallyidimethylammonium chloride, polyamines and polyethylene imines. The polymers may be linear, branched or cross-linked.

The polymers may be prepared by any convenient conventional process, for instance by solution polymerization, gel polymerization, reverse phase suspension polymerization and reverse phase emulsion polymerization. Suitable processes include those described in EP150933B2 or EP102759B1. The preferred polymers are non-ionic and cationic polymers of sufficiently high molecular weight such that it exhibits an intrinsic viscosity of at least 4 dl/g. Such an intrinsic viscosity generally indicates a polymer of several million molecular weight, for instance generally greater than 5,000,000 and usually at least 7,000,000. In general, the polymer preferably has an intrinsic viscosity greater than 6 dl/g, often at least 8 or 9 dl/g. The intrinsic viscosity can be as high as 30 dl/g or higher. In many cases though suitable cationic polymers exhibit an intrinsic viscosity in the range of 7 to 25 dl/g, in particular 10 to 20 dl/g, in particular around 14 or 15 dl/g.

The clean lignin, except for being dried if preferred, does not require any other treatment before mixing with the starch(s). Hence, the dried lignin is used as is. Because it does not need extensive washing or modification, it is much more economical than lignin produced by any other process.

These properties make such lignin a perfect candidate for making better and less expensive biodegradable starch foams and films. Its naturally water repellant attributes enhance starch foams, especially for use in packaging materials, insulating materials, and a myriad of other uses.

The reaction of the clean lignin with the starch can be performed in different ways depending on the intended application for the final product. The reaction can be done at or near to room temperature. However, it could also be possible to do the reaction at a temperature comprised between about 20° C. to about 30° C., about 30° C. to about 40° C., about 40° C. to about 50° C., about 50° C., about 60° C., about 60° C., about 70° C., about 80° C., about 90° C., about 100° C., about 110° C., about 120° C., about 130° C., about 140° C., or about 150° C., 160° C., 170° C., or higher.

Varying the amount of the lignin(s), starch(s), the blowing agent(s) and/or the additives, the process can be used to prepare a large variety of different starch/lignin products. These products can include, without being limited, to rigid foams, flexible foams, rigid boards, rigid blocks, coatings, packaging, binders, and the like.

Utility

In one embodiment, these foams provide value to applications that require single or limited use foam cushioning. Examples include packaging applications for food or consumer goods. Protective packaging is a market that considers sustainability a beneficial value proposition as packaging can create unintentional negative perceptions for a consumer. Examples of protective foam markets which would benefit from biodegradable starch-lignin foam include loose fill (peanuts) and extruded foam sheet. In one embodiment, a starch-lignin foam could be adapted to polymer injection molders to create shaped biodegradable foam parts. Given that the clean lignin described in this application can be certified as “generally regarded as safe (GRAS)” and it can be laminated, such products can include foam trays, package meats or clam-shell containers, cosmetics packaging, disposable tableware, including cutlery, cups, cup holders, lining materials for bags, biofiller for the automotive sector, bags, bottles, and the like.

Added Properties of Lignin

The advantages of combining clean lignin with a starch composite are multifold. In plants, lignin supports and protects the organs, especially the stems by providing a stiff, practically impermeable framework with cellulose and hemicelluloses. It has inherent properties such as hydrophobicity, ultraviolet light stability, flame retardation and compressive strength. Since most polymer packaging is made of petroleum-derived resources, replacing those polymers with lignin not only confers bio-based content with additional properties, but biodegradability as well. This lignin differs from pulp and paper lignin because it is processed differently, resulting in a different polymeric structure of uniform and small particle size, and having a different sulfur, carbohydrate and ash content. Further, due to the particular manner in which it is separated from hydrolyzed sugars, it tends to be very hydrophophic with a high molecular weight and a low bulk density. It is available in large commercial quantities and economical. In contrast, lignin from other biorefineries must be further cleaned and processed before it can even resemble this type of lignin. (See, e.g., U.S. Patent Pub. No. 2012/0108798 A1).

The starch-lignin foam in this formulation demonstrates improved water resistance over existing starch foams, thus expanding the potential applications that were limited due to dependence on ambient humidity. Compared to the starch foam sample, the water absorption capacity of the 40 wt % lignin:starch foam was reduced by 49%-63% after soaking for 15-30 minutes. The water absorption rate of the starch-lignin composite decreased by 60% after soaking for 10-15 minutes. Water absorption rate represents a composite's sensitivity to water and the results demonstrated that the reduction of the hydrophilicity of the biomass through this particular pretreatment greatly influenced the sensitivity to water. The results of this study are similar to research on cassava starch/natural fiber and starch foam/lignin, in that the water absorption index decreased with increasing of the fiber content, as well as corn fiber/starch/PVA foam where the water absorption was reduced by 21% and 49%. However, these lignin and corn fiber materials were chemically pretreated to reduce their hydrophilic nature.

The advantage of lignin-starch foams can be valued especially for single or short life cycle foam products. The polymer foam market is heavily used as protective packing for consumer goods (electronics, small appliances, etc.) and food products (meat trays, egg cartons, etc.). A common material is polystyrene foam due to its low cost and ease of manufacturability into a final product. However, this is a petroleum-based material that has a service life of decades and does not match the life cycle of the products it protects like eggs or meat. Polyethylene foam is often used for its low cost and improved cushioning over polystyrene. However it is harder to convert to a final shape and often requires cutting, gluing, stacking sheets, and other post processing to achieve the desired protection.

The present process allows the production of improved lignin/starch products containing relatively large amounts of lignin with improved homogeneity and composition, and/or better foaming qualities. Since lignin has natural UV protection properties, these foams are less likely to break down or crack under UV exposure conditions. They can also be manufactured more rapidly at lower cost. Since this clean biorefinery lignin is less expensive than conventional polyols, the cost is further reduced while having a smaller environmental footprint.

A further advantage of the short, uniform lignin fibers is improved fiber-matrix interaction in the foam. And the presence of cellulose increases the resistance of the fibers to moisture absorption. See, Reddy, N. and Yang, Y. (2014) Biocomposites from Renewable Resources. Pp. 441-443.

The process preferably does not require the use of any organic solvent as would other known processes. This is also beneficial for environmental and economic aspects.

In addition, the process does not require installing expensive new equipment. The same equipment as those known to produce starch products, or with minor modifications, can be used. The process can thus be readily implemented, limiting investment required to use this technology and modified to encompass any application.

In a further embodiment, clean lignin can be used for making films with such other natural products as cellulose. Films made with clean lignin can be used in many applications where UV protection is warranted. This includes packaging and protective films such as for edible materials, paints, glasses, such as sunglasses, cosmetics, and the like.

In another aspect, the products made by any of the processes described herein is provided.

### EXAMPLES

The following examples serve to illustrate certain embodiments and aspects and are not to be construed as limiting the scope thereof.

Materials

Making the starch-based foam blend with fiber involves the selection of starch, fiber, foam agent, and plasticizer. The lignin material (clean lignin) used in this study was produced by Sweetwater Energy (Rochester, N.Y., USA). It is a lignin-enriched nonsulfonated fractionated residue extracted following yeast fermentation. The fraction is comprised of 34.1% lignin, 22.3% cellulose, and 0.1% hemicellulose. Remaining contents include protein, ash, and lignin-carbon compounds.

The corn starch (MP Biomedicals) was comprised of 75% amylopectin and 25% amylose, with a pH level of 4.9, and approximately 11-15% moisture content. Tap water was used as a swelling agent. Citric acid and sodium bicarbonate, as blowing agents, were added into the starch mix to improve the cell growth and expansion characteristics. The critic acid monohydrate powder (EMD Chemicals) had a molar mass (MW) of 210.14 g/mol. Sodium bicarbonate (VWR), with a melting point of 60° C. and MW of 84.01 g/mol, was used in com-bination with the critic acid. Stearic acid 50 powder (Mallinckrodt Baker), with a specific gravity of 0.94 kg/L and melting point of 69° C., was incorporated as a starch granule swelling agent and external lubricant. Glycerol was added as a plasticizer into the starch foam extrusion to make the foam flexible (Table I).

TABLE 1
Processing Table

| | | Citric | Sodium | | |
|---|---|---|---|---|---|
| Starch/lignin | | Acid | bicarbonate | Glycerol | Water |
| foam | Starch:lignin | (wt %) | (wt %) | (wt %) | (wt %) |
| Matrix-1-1 | 100:0 | 1 | 1 | 25 | 10 |
| Matrix-2-2 | 100:0 | 2 | 2 | 25 | 10 |
| SB-80/20-1 | 80:20 | 1 | 1 | 25 | 10 |
| SB-80/20-2 | 80:20 | 2 | 2 | 25 | 10 |
| SB-60/40-1 | 60:40 | 1 | 1 | 25 | 10 |
| SB-60/40-2 | 60:40 | 2 | 2 | 25 | 10 |

Sample Preparation

Overall, all of the materials were mixed gravimetrically to yield 1 kg batches. First, starch was put into a convection oven for approximately 24 h at 90° C. to remove previously absorbed moisture. Mixing all of the materials into a homogenous blend takes place in a vertical mixer with a six quart mixing bowl where starch is poured into the mixing bowl first, followed by glycerol, continuously, for 10 min of mixing. Sodium bicarbon-ate and critic acid were weighed in one dish and stearic acid in another. After the 10 min mixing phase, the sodium bicarbonate, citric acid, stearic acid, and tap water were dispensed into the mixing bowl, with the mixer still in rotation. The materials were mixed for another 5 min. A primary shear process was performed by feeding the mixture through an electric meat grinder (LEM #779) as a secondary mixing process before the starch blends were fed into the single screw extruder. During the primary shearing process the lignin fraction was conglomerated into the starch before being fed through the meat grinder. The foam processing was derived from several published methods of Reims University (Abinader, G. et al. (2015) J Cell Past., 51:31; Averousa, L. et al. (2000) Polymer 41:4157).

Extrusion

The aforementioned starch/lignin mixture was then extruded through a single screw extruder (Yellow Jacket, Wayne Machine and Die Company). Starting from the feed throat, the temperature profile was as follows: 104, 124, 138, 138, 135, 132, and 132° C. The screw had a barrel diameter of 25.4 mm with a UD=30. Upon exiting the die, the foam extrusion passed through an aluminum tube simultaneously with compressed air for a quenching effect. The back pressure observed was 6.895 MPa at 50 screw/min.

Foam Characterization and Analysis

Samples were stored in open plastic bags and conditioned in an environment chamber at 23° C. and 53% RH for at least 1 week in order for moisture content in the starch foam composite to be equilibrated before carrying on the testing and evaluation specified below.

Density. The density was determined using the apparatus density determination kit (Ohaus Corporation). Because starch foam absorbs water, the gravimetric method cannot be directly applied to measure the density. This work combines the water absorption and gravimetric method, and subtracts the weight of the absorbed water from the sample immersed in the water. The foam density was measured by weighing a sample foam, both in the air and water, for computing its volume using the equation infra. Ten specimens were measured for each starch/biomass formulation.

$$ρ = \frac{A + {B}_{0}}{A + {B}_{0} - B} ( {ρ}_{0} - {ρ}_{L} ) + {ρ}_{L}$$

where p is the density of the sample (g/cm³), A represents weight of the sample in the air (g), B is the weight of the sample immersed in the water for 1 min (g), Bo is the weight of sample absorbed in water after 1 min of soaking (g), p0 is the density of the water (g/cm3), and P_{L} is the air density (0.0012 g/cm³).

The addition of short lignin fibers contributed to a lower composite density (Table II). The density of the starch foam without foaming is 1.46±0.1. Both matrix samples have a higher radial expansion than the samples containing biomass. The density of starch/natural fiber foam conducted by other studies ranges between 0.175 and 0.136 g/cm³ for starch-natural fiber foam,4 0.23-0.31 g/cm³ for starch-lignin foam (Stevens, et al. (2010) Expr. Polym. Lett., 4:311) and 0.20-0.32 g/cm³ for starch/sugarcane bagasse/PVA which are less than the foam/fiber density observed herein. The radial expansion of this study is close to starch-natural fiber foam (Bénézet, et al. (2012) Ind. Crops. Prod., 37:435). The overall relative lower radial expansion and higher density of the foam/starch samples in this study is due to the use of the single screw extruder. The foam density obtained from a single extrusion is usually twice the foam density produced from commercial facilities, with the same formulation (Pushpadass, et al. (2008) Packag. Technol. Sci., 21:171). In addition, the sodium bicarbonate content and the extruder temperature as well as the back pressure of the single extruder are also the factors that affect the foam density and expansion ratio (Abinader, G. (2015) J Cell Plast., 51:31).

Water Absorption and Water Uptake Rate. The immersion gravimetric method was used for measuring water absorption. Specimens of foams were cut into the size of 3 cm. The samples were weighed and immersed in a water bath for a specified interval of 5 min starting from 1 to 30 min. The amount of absorbed water was calculated as the weight difference between before and after the immersion. The reported values are the means of ten samples for each formulation.

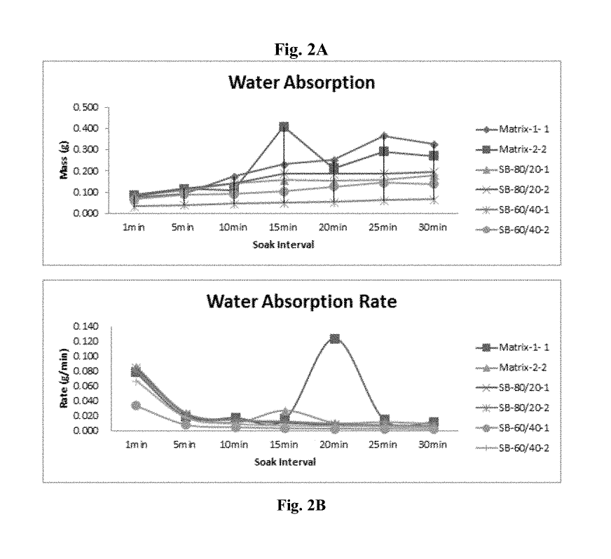

The nature of the starch and lignin fraction determined the water absorption capacity of the starch/lignin composite (FIG. 2A). The water absorption capacity of the samples went down significantly after adding the lignin fraction into the starch foam, especially with the 40 wt % lignin fraction. Noticeably, matrix-1 had a significantly higher water absorption weight and uptake ratio than other samples during the 15-20 min soaking time. This was probably due to the presence of the large cell areas in the matrix, allowing more water to be contained in the cells (Table III). Matrix-1 was taken out for comparison due to the aforementioned reason. Compared to the starch foam sample, the water absorption capacity of the 40 wt % lignin sample was reduced by 49-63% after soaking for 15-30 min. The water absorption rate of the starch-lignin composite decreased by 60.0% after soaking for 10-15 min. Water absorption rate represents a composite's sensitivity to water and the results demonstrate that the reduction of the hydrophilicity of the lignin fraction influenced the sensitivity to water.

Thermal Properties. The thermal properties of the starch-lignin foam were obtained through thermal gravimetric analysis (TGA) model TGA 500 manufactured by TA Instruments. TGA determines the mass loss (%) in the composite due to decomposition or loss of volatiles (such as moisture) through measuring the change in the mass of the sample when it is heated in a furnace.

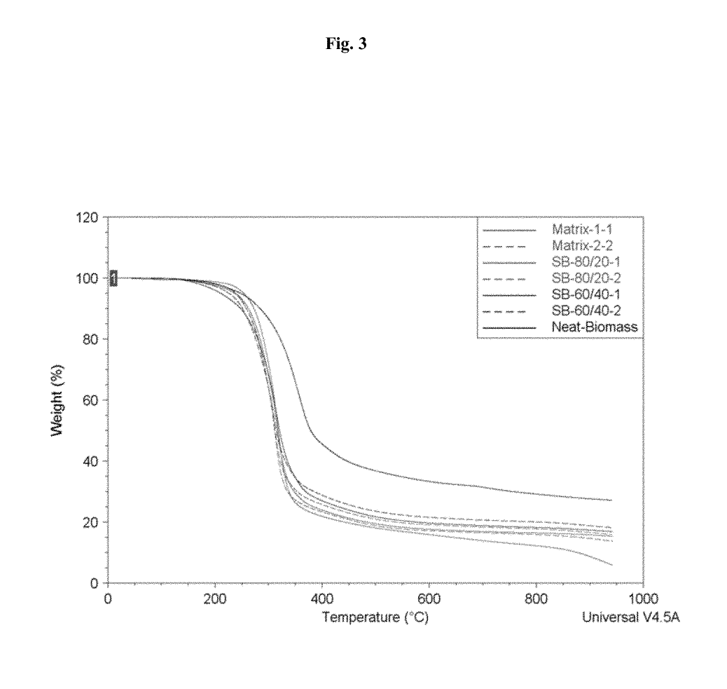

FIG. 3 shows that the neat starch started decomposition around 300° C. The neat lignin fraction began weight loss at around 200° C., indicating the start of decomposition of the lignin, and had a sharp drop between 300 and 400° C., indicating the weight loss of cellulose components in the lignin fraction. Then, a moderate drop of the weight loss of the neat lignin fraction occurred between 400 and 900° C., reflecting the lignin components. Overall, 75 wt % of the lignin fraction was vaporized. The residuals were most likely lignin-carbon (Askanian, H. et al. (2014) Holzforshung, 31:1; Jae, J. et al. (2010) Energ. Environ. Sci., 3:358) that was formed during repolymerization reaction during the hydrolysis steps. The TGA curve is in agreement with findings on the pyrolysis characteristics of the lignin (Yang, H. (2007) Fuel, 86:1781), such that lignin decomposition takes place slowly at a very low mass loss rate, and the significant residuals are left after 900° C. (ibid).

Compared to the neat lignin fraction and starch, the TGA curve of the lignin fraction showed a graduate stage decomposition range where the first drop corresponded to the decomposition with an onset temperature of 200° C., and the second decomposition region took place with an onset temperature of 300° C. that mirrored the beginning of the decomposition of the starch matrix and the remaining lignin components. The nonvaporized remains of the starch/lignin in the TGA curves correlated with the fractions of the lignin fraction added and its lignin-carbon component.

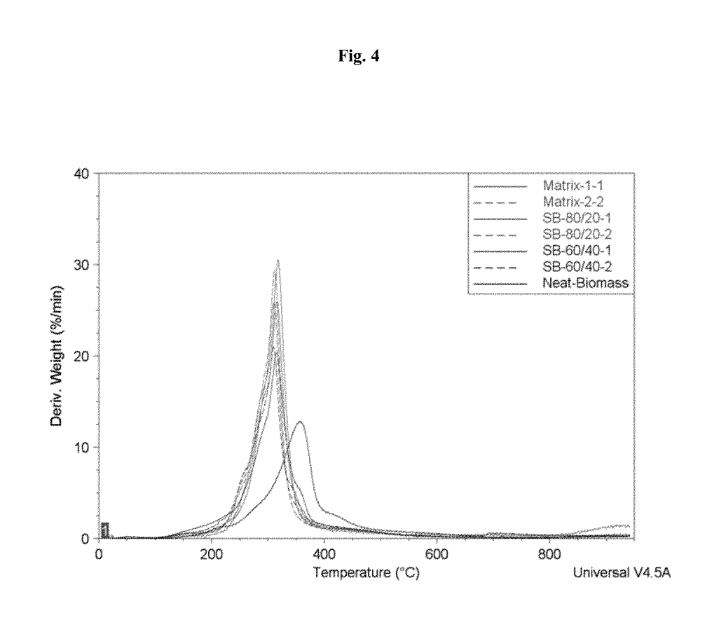

Derivative thermo-gravimetric analysis (DTG) curves show the decomposition rate (FIG. 4). The peaks at 300 and 350° C. correspond to the decomposition of the neat starch and the weight loss of the lignin fraction, respectively. The single DTG peak of blended starch/lignin foam occurred in the region around 300-310° C., representing mostly the starch decomposition temperature. This is because only a fraction of the lignin component is present in the starch/lignin foam (20-40 wt %), and of that, the 25% nonvaporized lignin-carbon fraction is not decomposable.

Scanning Electron Microscopy and Microscope. In order to investigate the dispersion of the lignin fraction in the starch matrix, the cross sectional profiles of the samples were examined by microscope and scanning electron microscopy (SEM) in two different magnifications: 35× and 80×. At 35× magnification, the overall distribution of the cell structure in the foam composite was assessed. Then SEM pictures were obtained at SOX magnification to show the dispersion of the lignin fraction in the matrix and whether there is an adhesion between the lignin fraction and the matrix present in the composite. A piece of foam sample along the cross section was cut into the approximate dimensions of 0.30×0.30×0.30 cm. These samples were then sputter coated with AuPd to make them conductive. The cross sectional profile of the samples was then examined by SEM.

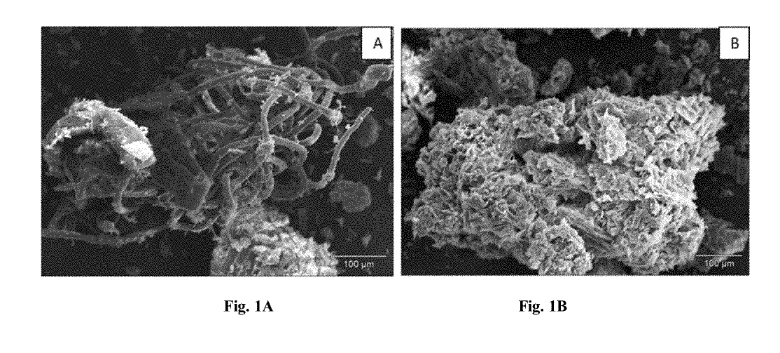

A scanning electron microscope (SEM) micrograph of the lignin fraction is illustrated in FIGS. 1A and 1B. Two types of morphological structures were found and distinguished clearly from each other. They are the cellulose (1A) and lignin components (1B). The length of the cellulose fibers is long, about hundreds of microns long, and the diameter of the cellulose is about 15 μm. The lignin fibers are all relatively shorter, most of them measuring around 20 μm long. The SEM result confirmed that not all of the cellulose was converted to sugar and about 22.3 wt % of the cellulose still remained in the lignin fraction.

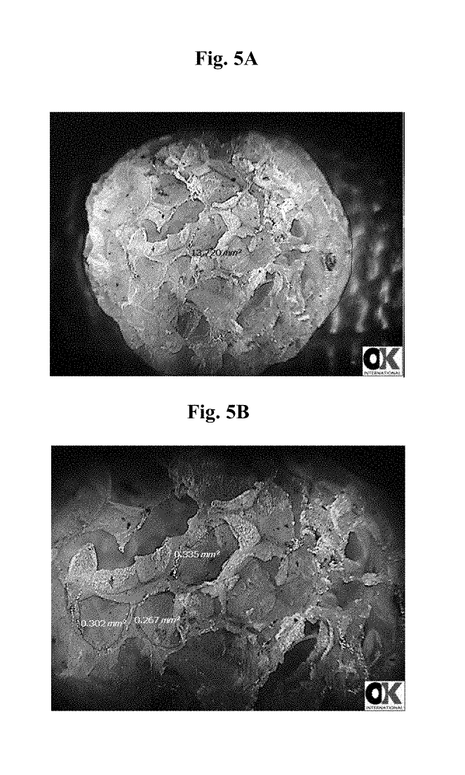

FIG. 5 illustrates the morphology of exemplary cross section profiles of the foam. Table III shows that the control sample with 1 wt % foaming agent has the most cell areas among the measured samples. When the 20 wt % biomass was added, the cell areas of the 1 wt % foaming agent sample were reduced, and the cell areas of the 2 wt % foaming agent sample was increased. When further increasing the lignin fraction loading to 40 wt %, the number of the cells increased in all samples. In the presence of the 2 wt % foaming agent, 40 wt % lignin fraction of the starch resulted in an increase in both cell number and cell area compared to the matrix samples. In general, adding lignin fraction increased the cell numbers and cell areas with the exception of SB-80/20-1. On one hand, the lignin fraction increased the viscosity of the starch so that the cell growing ability is lowered. On the other hand, the lignin fraction played a role as a nucleating agent that helped increase the number of cells. The lignin fraction was not completely wetted during the polymer melting due to the high viscosity and contact angle restraint. Therefore, the gas cavities at the interface between the starch matrix and lignin fraction could be created, which lead to form the micro cells.

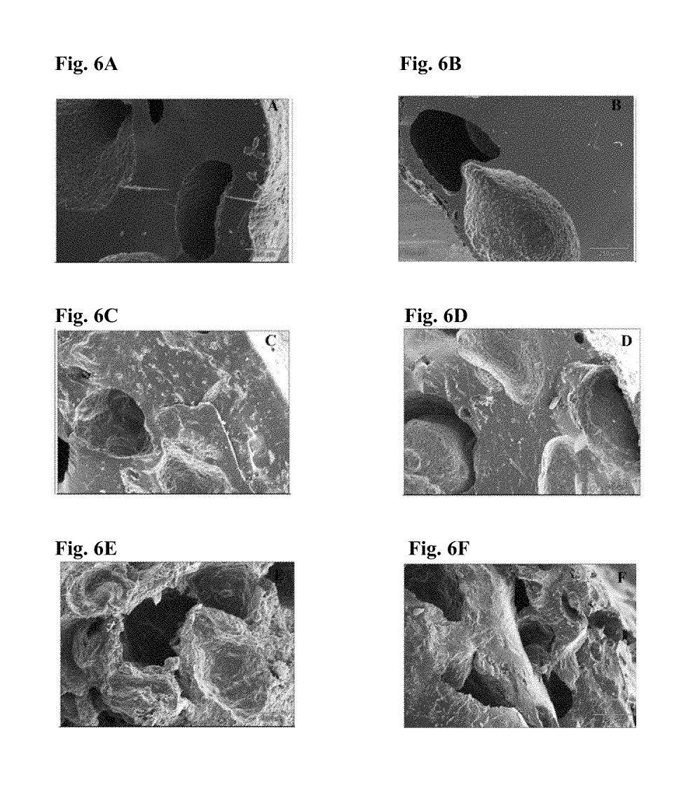

FIGS. 6A and 6B show that the starch-only foam had a relatively smooth surface, and the wall thickness is thick, with all closed cells. The surface of the lignin-added foams are rough and some of the samples have cracks (FIGS. 6C-6F). The starch foam appears to have dispersed well with the biomass. Noticeably, most of the original long cellulose fibers seen in FIG. 1 of the raw biomass have disappeared. The disappearance of the fibers is probably due to the cellulose melting at 136.24° C., and the starch forming linkages with the cellulose during the extrusion process under the extrusion temperature of about 138° C. Because the sample only consists of 0.1% hemicellulose, the residuals observed are most likely the lignin. This finding is similar to the results of research of Guan and Hanna ((2004) Ind. Crop. Prod., 19:255, wherein it was shown that lignin and hemicellulose tend to maintain the matrix in starch-fiber foams manufactured at temperatures above the melting point of cellulose. However, the results are unlike that of Stevens (Stevens S. (2010) Expr. Polym. Lett., 4:311) in that starch/lignin foam's morphology does not change after replacing 20% of starch with lignin. It is likely due to the difference between kraft pine virgin lignin and biorefinery lignin. Compared to the starch foam with the same forming agent and plasticizer (Abinader, G. (2015) J Cell Plast., 51:31), the cell densities (cell numbers/cross section area) of the twin extruder-produced foam were between 15.0 and 50.8 cells/cm². The cell densities of this study were much smaller, ranging from 7.97 to 15.2 cells/cm2, and after adding the lignin fraction, the cell density of the foam/lignin fraction increased to 31.6 cells/cm² (Tables II and III).

Compression Test. It is difficult to conduct a compression test for a single extruded foam sample. For this reason, multiple sections of the extruded foam were cut perpendicular to the machine direction at a length of 3.80 mm. Five samples with the most identical length and diameter were selected. The five samples were sandwiched between two aluminum discs with five holes and oriented such that stress was applied in the machine direction. The diameter of each section was measured and a mean diameter was calculated and used to compute the cross sectional area of each sample, the sum of all five areas was then entered into the program (Instron model 5567 with Blue-hill 2 interface). The method was set to five compression cycles at a rate of 12 mm/min and a compression stress at 50% stain.

In general, the starch/lignin foam showed a reduction in compressive strength when the lignin fraction was added, except in the case of the sample foam SB-80/20-1. Comparing the compressive strength in Table III, the foams with most cells and cell areas exhibited a lower compressive strength, and the foams with the least cells, i.e., SB-80/20-1, had the highest compressive strength. Thus it appears that the compression strength of the starch/lignin fraction is largely contributed by the starch foam, not the lignin fraction. From the Young's modulus in Table III, overall, the stiffness of the lignin fraction -added starch foam was slightly reduced when compared to the starch foam sample.

While most studies on starch/fiber foams measure the mechanical strength by tensile testing, and have concluded that adding fiber does enhance the tensile strength for most fibers, few studies have used compression strength as the measurement of the mechanical strength, and their results were not the same as the tensile strength of the starch foam/fiber. The compressive strength of starch/PVA/natural fiber (Mali, S. et al. (2010) Ind. Crop. Prod., 32:353) ₛh_{owe}d the same results as the foam without the fiber. In Teixeira's study, (Teixeira, E. D. M. (2014) RSC Adv. 4:6616) the starch foam/fiber has less compressive strength (0.46 Mpa) than starch only foam (1.18 Mpa); however, the starch/PLA/fiber exhibited better compressive strength (2.54 Mpa). Most of the foam samples had a lower flexural strength than the foam samples without lignin, except for one combination with lower concentrations of foam agent and lignin fraction.

TABLE II
Density and Radial Expansion of the Starch/lignin fraction Foam.

| | Cross | | |
|---|---|---|---|
| Starch/lignin | sectional Area | Density | Radial |
| fraction foam | (mm²) | (g/cm³) | expansion |
| Matrix-1-1 | 53.6 ± 1.27 | 1.05 ± 0.03 | 2.54 ± 0.08 |
| Marix-2-2 | 42.6 ± 1.84 | 1.04 ± 0.03 | 2.15 ± 0.03 |
| SB-80/20-1 | 48.5 ± 0.69 | 0.99 ± 0.01 | 2.07 ± 0.05 |
| SB-80/20-2 | 38.9 ± 1.04 | 1.01 ± 0.01 | 1.07 ± 0.06 |
| SB-60/40-1 | 49.4 ± 1.48 | 0.99 ± 0.02 | 2.01 ± 0.04 |
| SB-60/40-2 | 41.4 ± 1.82 | 0.93 ± 0.01 | 1.62 ± 0.08 |

TABLE III
The Measured Cell Numbers and Mechanical Properties
of the Starch/lignin fraction Foam

| | Number | Area sum | | |
|---|---|---|---|---|
| | of cells | of cells (%) | Compressive | Young's |
| Starch/lignin | in cross | in cross | Strength | modulus |
| fraction foam | section | section | (MPa) | (MPa) |
| Matrix-1-1 | 4.30 ± 1.50 | 27.0 ± 1.90 | 7.461.77 | 26.3 ± 4.49 |
| Matrix-2-2 | 6.50 ± 1.30 | 11.8 ± 0.30 | 9.17 ± 1.94 | 22.3 ± 2.93 |
| SB-80/20-1 | 3.50 ± 1.00 | 7.5 ± 0.40 | 9.67 ± 0.70 | 29.7 ± 2.68 |
| SB-80/20-2 | 11.5 ± 1.90 | 24.0 ± 0.80 | 6.10 ± 1.04 | 19.8 ± 2.96 |
| SB-60/40-1 | 12.0 ± 3.60 | 19.3 ± 0.50 | 5.33 ± 1.49 | 20.0 ± 3.77 |
| SB-60/40-2 | 13.0 ± 4.70 | 25.2 ± 0.40 | 6.37 ± 1.92 | 19.4 ± 4.57 |

Conclusion

The residuals from the second generation bioethanol hold great promise as potentially widely used biodegradable filler thanks to its unique functionality through the enzymatic hydrolysis process. The lignin-enriched fraction, after the extraction of the CS and C6 sugars, can change the hydrophilic nature of the starch foam. Both water absorption capacity and sensitivity to the water of the starch/lignin foam reduced in great extend in the presence of the lignin fraction. When compared to the starch only foam, the developed starch/lignin foam demonstrated a denser and smaller morphological cell structure in the foam, a lower foam density, as well as the reduced compressive strength and stiffness. The thermal properties of the starch/lignin mainly reflected the starch's thermal degradation behavior. This study concluded that the clean lignin fraction from the second generation cellulosic ethanol production could potentially suppress the original natural fiber and provide a more cost effective and sustainable reinforcement for the starch foam than other starch/lignin foams. Additional starch/lignin foams can also be produced using twin extruder and commercial foaming facilities to make a lower foam density and higher expansion ratio in such foams.

### Example 2

### Particle Size Following Pretreatment with a Twin Screw Extruder

The experiment was conducted to evaluate the particle size reduction that takes place during biomass pretreatment in a modified twin screw extruder. Cherry sawdust, with an average particle size of about 3 mm×3 mm×1 mm and an average moisture content of 31% was used as the raw biomass feedstock. The cherry biomass was fed into a ZSK-30 twin screw extruder, manufactured by Coperion, essentially as described in Example 1. The processing parameters used for the experiment are presented in Table 4.

TABLE 4
Particle Size Distribution Experimental Parameters

| | Mass | | | Acid | Water | Residence |
|---|---|---|---|---|---|---|
| | Throughput | Pressure | Temp. | Addition | Addition | Time |
| Feedstock | Dry g/min | psig | ° C. | g/min | g/min | seconds |
| Cherry | 398.4 | 400 | 231 | 7.6 | 1134 | 10 |
| Sawdust | | | | | | |

The cherry sawdust was processed on a continuous basis. The final moisture content of the processed cherry sawdust was about 76.8%. Once steady state was achieved a sample of the pretreated material was collected for particle size analysis. The sample was analyzed through a Mie Scattering theory using a Horiba LA-920, capable of measuring particle diameters from 0.02 μm to 2000 μm. The results indicated a significant particle size reduction occurring throughout the pretreatment process. The average particle size was reduced from 3 mm in the raw material to 20.75 μm in the pretreated effluent.

### Example 3

### Bulk Density of Hydrolysate-Derived Lignin

Two 250-mL samples of lignin were prepared and shipped for testing to determine bulk density as well as other powder flow characteristics. The majority of one sample had a mean particle size of 10-μm. The second sample was placed through a 1-mm sieve where all particles 1-mm and smaller were allowed to pass through. The 1-mm sieve was selected based on the maximum particle size allowable for the powder flow measurement technology. The lignin was derived from barkless mixed hardwood.

The hardwood was pretreated using the above-described pretreatment technology for conversion of available C5 sugars. The material was subsequently subjected to enzymatic hydrolysis and separation for the removal of available C6 sugars. The remaining lignin in suspension was then processed for solids removal. The material was initially separated to 50% total solids removing the majority of the dissolved solids in solution. Remaining sugars were measured to be 0.04, 0.06, and 0.07-g_{sugar}/g_{cake} at sample points.

The lignin was granulated and allowed to dry further to 10% moisture prior to preparation of the samples. After drying the material was sent directly through a 1-mm sieve to recover a 250-mL sample of sizes 1-mm or less. A separate 250-mL sample was produced by pulverizing the agglomerated particles into their fundamental sizes which average 10-μm.

The dry lignin powder had a bulk density of 461-750 kg/m³.

### Example 4

### Content of Hydrolysate-Derived Lignin.

Analysis of hydrolysate-derived lignin is shown in Table 5.

TABLE 5
Analysis of lignin

| | | | Moisture | As |
|---|---|---|---|---|
| Test | Method | Units | Free | Received |
| Moisture Total | ASTM E871 | wt. % | | 22.74 |
| Ash | ASTMD1102 | wt. % | 1.68 | 1.30 |
| Volatile Matter | ASTM D3175 | wt. % | 62.50 | 48.29 |
| Fixed Carbon by | ASTM D3172 | wt. % | 35.82 | 27.68 |
| Difference | | | | |
| Sulfur | ASTM D4239 | wt. % | 0.174 | 0.134 |
| SO₂ | Calculated | Lb/mmbtu | | 0.317 |
| Net Cal. Value at | ISO 1928 | GJ/tonne | 23.01 | 13.18 |
| Const. Pressure | | | | |
| Net Cal. Value at | ISO 1928 | J/g | 23012 | 13182 |
| Const. Pressure | | | | |
| Gross Cal. Value | ASTM E711 | J/g | 24231 | 18721 |
| at Const. Vol. | | | | |
| Gross Cal. Value | ASTM E711 | Btu/lb | 10418 | 8049 |
| at Const. Vol. | | | | |
| Carbon | ASTM D5373 | wt. % | 59.43 | 45.92 |
| Hydrogen* | ASTM D5373 | wt. % | 5.63 | 4.35 |
| Nitrogen | ASTM D5373 | wt. % | 0.53 | 0.41 |
| Oxygen* | ASTM D3176 | wt. % | 32.56 | 25.16 |
| Chlorine | ASTM D6721 | mg/kg | 36 | 28 |
| Fluorine | ASTM D3761 | mg/kg | 9 | 7 |
| Mercury | ASTM D6722 | mg/kg | 0.001 | 0.001 |

As received values do not include hydrogen and oxygen in the total moisture.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An expanded matrix, comprising a mixture of starch comprising amylose and amylopectin, and clean lignin, the lignin being present in a % weight ratio of from about 1:99 to about 50:50 of the starch, the expanded matrix having a uniform distribution of cells throughout.

2. The expanded matrix according to claim 1, wherein the starch comprises from about 10% to 90% amylose by weight.

3. The expanded matrix according to claim 2, wherein the starch comprises about: 10%, 15%, 20%, 25%, 30%, 35%, 40%, 45%, 50%, 55%, 60%, 65%, 70%, 75%, 80%, 85%, or 90% amylose by weight.

4.-6. (canceled)

7. The expanded matrix according to claim 1, wherein the matrix is flexible.

8. The expanded matrix according to claim 1, wherein the matrix is rigid.

9. The expanded matrix according to claim 1, having a lower compressive strength compared to an expanded matrix of pure starch.

10. The expanded matrix according to claim 9, wherein the expanded matrix has a compressive strength of 0.10 to 0.18 MPa.

11. The expanded matrix according to claim 1, wherein the mixture comprises 1-10% by weight lignin, and the expanded matrix has a unit density of less than about 39 kg/m3, a resiliency of at least 63%, and a compressive strength of at least 0.14 MPa.

12.-13. (canceled)

14. The expanded matrix according to claim 1, comprising at least 10% by weight lignin, wherein the expanded matrix is configured to remain intact after immersion in water for longer than 12 h.

15. (canceled)

16. The expanded matrix according to claim 1, further comprising at least one additive which does not chemically interact with the starch or lignin.

17. The expanded matrix according to claim 1, comprising a uniform foam produced within a heated extruder.

18. The expanded matrix according to claim 1, wherein the mixture comprises 1-40% by weight lignin and further comprises 1-20% by weight cellulose fibers, the expanded matrix having a unit density of less than about 61 kg/m3, a resiliency of at least 56%, and a compressive strength of at least 0.18 MPa.

19.-20. (canceled)

21. A method of forming a product, comprising: mixing about 1-50% by weight clean lignin and starch in an aqueous medium; and extruding the lignin-starch mixture under heat and pressure to form an expanded foam.

22.-25. (canceled)

26. The method according to claim 21, wherein the expanded foam comprises 20-40% by weight lignin and 5-20% by weight cellulose fibers, and the expanded foam has a reduced water absorption capacity of 40-60% after immersion in water for 15 min compared to a pure starch expanded foam.

27. The method according to claim 21, wherein the starch is chemically unmodified starch, and wherein the expanded foam has: a uniform distribution of cells throughout, approximately 13±4.70 cells in cross section, and a sufficient amount of lignin to provide water resistance to retain structural integrity in aqueous liquid.

28. The expanded matrix according to claim 1, wherein the expanded matrix is characterized by the following:
(a) the clean lignin having an average particle size of about 20 μm;
(b) a decreased water absorption rate in comparison to an expanded matrix without the clean lignin; and
(c) increased hydrophobicity in comparison to the expanded matrix without the clean lignin.

29.-47. (canceled)

48. A method of producing a water-resistant starch-lignin foam, the method comprising:
(a) combining starch, glycerol, water, and a lignin composition to form a mixture; and
(b) subjecting the mixture to an elevated temperature and an elevated pressure to form the water-resistant starch-lignin foam.

49.-58. (canceled)

59. The method of claim 48, wherein a water absorption capacity of the water-resistant starch-lignin foam is decreased by at least 20% relative to a starch foam produced by the same method without the lignin composition.

60. The method of claim 48, wherein a water absorption capacity of the water-resistant starch-lignin foam is decreased by at least 30% relative to a starch foam produced by the same method without the lignin composition.

61.-151. (canceled)

152. The method of claim 48, wherein a water absorption capacity of the water-resistant starch-lignin foam is decreased by at least 10%, 20%, 30%, 40%, 50%, or 60% relative to a starch foam produced by the same method without the lignin composition.

153.-171. (canceled)

172. The method of claim 48, wherein the water-resistant starch-lignin foam has a compressive strength of at least about: 0.5 MPa, 1 MPa, 2.5 MPa, or 5MPa.

173.-237. (canceled)
